(19) United States
(12) Patent Application Publication
(10) Pub. No.: US 2005/0245397 A1
(43) Pub. Date: Nov. 3, 2005

(54) Use of nickel to correct growth disorders in plants

(76) Inventors: Bruce W. Wood, Byron, GA (US); Charles C. Reilly, Warner Robins, GA (US); Andrew P. Nyczepir, Centerville, GA (US); Mark A. Crawford, Valdosta, GA (US); Rufus L. Chaney, Beltsville, MD (US)

Correspondence Address: USDA, ARS, OTT, 5601 SUNNYSIDE AVE, RM 4-1159, BELTSVILLE, MD, 20705-5131, US

(21) Appl. No.: 11/083,182

(22) Filed: Mar. 16, 2005

Related U.S. Application Data
(60) Provisional application No. 60/565,387, filed on Apr. 23, 2004.

(51) Int. Cl. A01N 25/00; A01N 63/00

(52) U.S. Cl. 504/116.1

(57) ABSTRACT

Nickel foliar sprays are used to correct growth disorders in plants associated with nickel deficiencies. The nickel can be of either an organic or inorganic source.

This application is a non-provisional application claiming benefit of provisional application 60/565,387, filed Apr. 24, 2004.

### BACKGROUND OF THE INVENTION

1. Field of the Invention

This invention relates to the use of nickel to cure growth disorders caused by nickel deficiencies in various crops including trees, shrubs, and landscape ornamentals. It also relates to compositions containing nickel useful for curing these deficiencies.

2. Description of the Related Art

Many growth disorders of unknown cause in crops such as trees, shrubs and landscape ornamentals exist. Examples of these include mouse-ear of pecan, little leaf of River Birch, blunted foliage on plum, peach, nectarine, citrus, apple, pear, grape, walnut, almond, and pistachio, etc. There are also replant diseases and disorders associated with these crops that are potentially tied to micronutrient nutrition.

Mouse-ear (ME) is a growth abnormality in trees such as pecan [Carya illinoinensis (Wangenh.) K. Koch] first reported in 1918 by Matz (Florida Agr. Exp. Sta., Bul. 147:135-163, 1918). It was initially exhibited by yard trees within certain Florida, southern Mississippi, and southeastern Georgia cities (Demaree, Phytopathology, V. 16 (4), 277-283, 1926). It was evident in pecan orchards by the 1930's and is now a common anomaly in many Gulf Coast Coastal Plain soils. Such soils are typically low in Ni, Zn, and Cu (Homgren et al., J. Environ. Qual., Volume 22, 335-348, 1993). The anomaly was once suspected of being caused by a virus, then later attributed to being a nutritional disorder.

Gammon and Sharpe (Proceedings Amer. Soc. Hort. Sci., Vol. 68, 195-200, 1956) concluded that the problem was a manganese deficiency; however soil or foliar application of Mn to affected trees does not correct mouse-ear in contemporary orchards.

Several morphological and physiological symptoms for mouse-ear are described. Important symptoms include dwarfing of tree organs, poorly developed root system, rosetting, delayed bud break, loss of apical dominance, reduced photoassimilation, nutrient element imbalance in foliage, and increased water stress. The disorder is not graft transmissible and is only temporarily mitigated by pruning. Degree of severity within the tree canopy typically increases with canopy height. There has been considerable establishment of 2^{nd} generation pecan orchards and replacement of missing orchard trees over the last 20 years in the southeastern United States. It is common for these newly transplanted trees to exhibit mouse-ear symptoms the 2^{nd} or 3^{rd} year after transplanting. In many cases symptoms are so severe that transplants die. This “replant” associated form of mouse-ear is a serious economic problem for many orchard operations throughout the Georgia pecan belt and certain orchards within the Gulf Coast Coastal Plain of the southeastern United States.

Mouse-ear is typically identified by a leaflet deformity shaped to resemble the ear of a mouse. Slight to moderate forms of mouse-ear occur sporadically through the canopy and are often evident on a single major limb or terminal shoot. The anomaly first appears on the spring flush of shoots. It can consistently reappear from year to year, or appear only occasionally, on the same trees. Its occurrence is often spotty, and highly variable within affected trees and orchards. The severe form of mouse-ear, called replant disorder, is becoming increasingly evident on replant trees in older orchards and usually becomes evident the second or third year after transplanting. It can range from slight leaflet growth distortion to gross deformity of shoot, foliar and reproductive organs of such severity that trees die. Severely affected trees grow very slowly and are greatly delayed in producing nut crops.

In more recent years, as a consequence of the general failure of manganese foliar sprays or soil applications to correct mouse-ear, it appeared that the most likely candidate nutrient element was copper. It is presumed that the failure of manganese to correct mouse-ear is because earlier sources contained nickel as a trace contaminant whereas modern fertilizer processing methods have essentially removed nickel contamination. Copper is peculiar among nutrient elements in that it binds tightly to newly formed cell walls and also to plant proteins, thus becoming unavailable for normal physiological needs of plant cells. It becomes physiologically available a few weeks post bud break as these cell wall binding sites become saturated. Thus, nutrient analysis of copper deficient tissues often reveal an abundance of total copper but a deficiency in physiologically available copper. The observation that late spring or summer growth of shoots from all but the most severely affected mouse-ear trees is typically normal, was consistent with what one would expect to see if copper were indeed involved. While copper is the most prominent of the micronutrients that exhibit this binding characteristic, it is not the only one.

Over the years, it has been discovered that mouse-ear symptoms can often be eventually corrected, after 3 or more years, by addition of phosphorus, sulfur, or copper fertilizer products to soils. Foliar sprays of copper, regardless of the copper source, usually did not provide improvement and often made the problem worse. It was later found that these phosphate and copper sources contained nickel as a trace contaminant. Usage of sulfur acidified the soil, thus it increased the availability of nickel for root uptake. It has been noted that the disorder is much worse in dry springs than in wet springs. It has also been found that trees with severe mouse-ear have considerable damage to roots by rootknot nematodes. Severely affected trees were also associated with soils linked to pre-existing trees. However, severe mouse-ear could also occur without the presence of nematodes. Furthermore, mouse-ear could be induced by exposing young trees to high levels of zinc, iron, or copper. It was also noted that in certain situations, mouse-ear could be partially corrected by timely treatment of foliage with a plant growth regulator called gibberellic acid.

In cases of potted seedlings, Goff and Keever (HortScience, Vol. 26, 383-386, 1991) discovered that mouse-ear could be induced by application of calcium. Also, Grauke et al. (Proc. Southeastern Pecan Growers Assn., Vol. 76, 141-147, 1983) noted that in potted seedlings mouse-ear was also associated with excessive nitrogen. Grauke noted that it is uncertain that mouse-ear symptoms expressed on field trees is the same disorder, or has the same causal factors, as that of mouse-ear exhibited by potted seedlings. It is noteworthy that high calcium or nitrogen levels in potted seedlings can potentially cause an imbalance in micronutrient nutrition.

Research in treatment of plant growth disorders, such as mouse-ear, is especially difficult for several reasons. One reason is the great variability of symptoms and their severity being expressed within and among trees. Thus, experiments had to be carefully controlled and highly replicated in order to ensure that results reflected reality. The innate nature of trees to grow out of an abnormality within a couple of months after bud break made it especially difficult because of the danger of misinterpreting a treatment as correcting the abnormality when in fact it was ineffective. Thus, false positives are easily found in observations. Until the present invention, after several decades of sporadic effort, a consistently effective control for growth disorders such as mouse-ear had not been identified.

Zinc deficiency has been reported to cause a “little leaf” disorder, producing small and narrow leaves, but without the defining blunted apical tip that is characteristic of a Ni deficiency. Note that this “little leaf” growth disorder is not similar, and is distinctly different, to that form of “little leaf” associated with mouse-ear. Deficiency symptoms are usually associated with small leaves, blind wood on last year's growth and a cluster of normal leaves at the terminal end of affected limbs. Symptoms of Zn deficiency may include a yellowing or loss of chlorophyll in interveinal areas of some leaves. Spur leaves may show deficiency symptoms before terminal leaves. The yellowing and rosetting may not be evident in cases of mild deficiency. A combination on Zinc and Boron late in the season (2-3 weeks prior to leaf drop) will help protect the buds over winter and harden off the trees.

While various treatments have been developed for various growth disorders of plants, such as mouse-ear, there remains a need in the art for treatments of growth disorders in plants. The present invention provides nickel compositions which are different from prior art compositions and solves some of the problems associated with prior art treatments.

### SUMMARY OF THE INVENTION

It is therefore an object of the present invention to provide a method for treating growth disorders in plants caused by a nickel deficiency such as, for example, mouse-ear, little leaf, blunted foliage, replant disorder, etc., wherein said plants receive a composition comprising nickel.

A further object of the present invention is to provide a nickel composition useful for treating growth disorders in plants caused by a nickel deficiency such as, for example, mouse-ear, little leaf, blunted foliage, replant disorder, etc.

A still further object of the present invention is to provide a nickel composition for application to plants with growth disorders caused by nickel deficiencies wherein said nickel is either inorganic or organic nickel.

Another object of the present invention is to provide a nickel composition for application to plants wherein said nickel is extracted from a plant that hyperaccumulates nickel when used in phytoextraction.

A still further object of the present invention is to provide a method for treating growth disorders in plants caused by a nickel deficiency, such as, for example, mouse-ear, little leaf, blunted foliage, replant disorder, etc., wherein a composition containing an inorganic or organic source of nickel is applied to said plant.

A further object of the present invention is to provide a method for treating growth disorders in plants caused by a nickel deficiency, such as, for example, mouse-ear, little leaf, blunted foliage, replant disorder, etc., wherein a composition containing inorganic or organic nickel source is applied in amounts effective to at least lessen the severity of said growth disorders.

Another object of the present invention is to provide a method for treating growth disorders in plants caused by a nickel deficiency wherein said nickel is applied at a concentration of from about 1 ppm to less than about 200 ppm or from about 1 mg·L⁻¹ to about 200 mg·L⁻¹.

Further objects and advantages of the invention will become apparent from the following description.

### BRIEF DESCRIPTION OF THE DRAWINGS

The patent or application filed contains at least one drawing executed in color. Copies of this patent or patent application publication with color drawings will be provided by the Office upon request and payment of the necessary fee.

FIGS. 1A-1G are photographs showing characteristics of severe mouse-ear: Mouse-ear-like shaped foliage (A); rosetting (B); bud break of multiple buds on one-year-old shoots (C); elongated and pointed buds (D); dwarfed shoots (E); delayed bud break (F); and dwarfed catkins (G).

FIG. 2 is a graph showing the relationship of degree of severity of mouse-ear to general location of foliage within the canopy of trees between 4 and 12 meters tall. Severity classes are: 1=no mouse-ear; 2=trace with about <1% of foliage being distorted; 3=slight with about 1-10% of foliage being distorted; 4=moderate with about 11-50% being distorted; 5=heavy with about 51-100% being distorted; 6=very heavy with about 100% leaf distortion but no resetting; 7=severe with resetting.

FIGS. 3A-3D are graphs showing comparison of mouse-ear and unaffected trees during mid-morning and mid-afternoon for photoassimilation (A; FIG. 3A), stomatal conductance (Sgw; FIG. 3B), leaf transpiration (E; FIG. 3C), and leaf water potential (Ψω; FIG. 3D). Differences in treatment means are identified by T-tests (P=0.05) with differences noted by different letters. Comparisons are mouse-ear mid-morning versus unaffected mid-morning (a and b denote statistical differences), mouse-ear mid-afternoon versus unaffected mid-afternoon (a and b denote statistical differences) and unaffected mid-morning versus unaffected mid-afternoon (a and b denote differences.)

FIG. 4 shows linear regressions of the relationships between severity classes of mouse-ear on the same affected tree during stage of mouse-ear development (April) and g-atom concentrations of nutrient elements in developing foliage. The correlation of N, K, Mg, Fe, Cu, and Mn exhibited r² values less than 0.35 and were not significant at P=0.05 whereas the significant associations were as follows: P(r²=0.61), Al (r²=0.72), Zn (r²=0.68), Fe(r₂=0.84), Na (r²=0.39), and B(r²=0.62) increased with severity of mouse-ear and Ca (r²=0.54) and Cu (r²=0.48) decreased with severity of mouse-ear. The statistically significant macronutrients are in ‘A’ and the micronutrients are in ‘B’.

FIGS. 5A and 5B are graphs showing the occurrence of mouse-ear in young ‘Desirable’ trees planted as a second generation orchard. The previous orchard was comprised of approximately 80 year-old ‘Success’ trees that were under commercial management. Tree spacing in the old ‘Success’ trees was about 18.3 m×18.3 m, whereas in the new orchard it is about 18.3 m×9.15 m. Codes are as follows: ●=existing orchard of 80 year-old trees; X=location of preexisting ‘Success’ trees and where ‘Desirable’ trees were transplanted; ME=‘Desirable’ trees exhibiting symptoms of mouse-ear; N=‘Desirable’ trees exhibiting unaffected growth (no moue-ear). The pattern of mouse-ear illustrates the replant disorder evident in pecan orchards, and those of other crops.

FIG. 6 is a photograph of a pecan branch showing a comparison of April shoot growth from severely mouse-eared trees treated with a foliar spray of Nickel the previous October. The nickel treatment is on the left and the untreated control is on the right.

FIG. 7 is a photograph of a pecan tree showing the influence of spring foliar application of nickel on severity of mouse-ear symptoms of orchard trees. The branch on the left side of the tree was treated with nickel soon after bud break whereas the right portion of the tree was not treated.

FIGS. 8A and 8B are graphs showing the influence of October foliar application of copper and nickel at different treatment conditions on severity of mouse-ear the following spring. Treatments are such that for Ni, X=about 3.53 grams NiSO₄.6H₂O per liter (8A) and for Cu, X=1.98 g CuSO₄.5H₂O per liter (8B). For Nickel (8A), y=1/(x+0.205), R²=0.45, P=0.0001; Cu (8B) y=2.95+2.06x-o.183x², R²=0.54, P=0.0001.

FIG. 9 is a graph showing the corrective effect of foliar application of nickel sulfate hexahydrate on mouse-ear severity when applied at concentrations of about 10 ppm or greater or about 10 mg·L⁻¹ or greater in the spring during bud break of pecan seedlings.

FIG. 10 is a graph showing the corrective effect of foliar application of a nickel extract from Alyssum sp. on mouse-ear severity when applied at concentrations of about 10 ppm or greater or about 10 mg·L⁻¹ or greater in the spring during bud break of pecan seedlings.

FIG. 11 is a graph showing the corrective effect of foliar application of nickel lignosulfonate on mouse-ear severity when applied at concentrations of about 10 ppm or greater or about 10 mg·L⁻¹ or greater in the spring during bud break of pecan seedlings.

FIG. 12 is a graph showing the efficacy of nickel sources for correcting mouse-ear with 4 replicates per treatment as indicated by the shaded bars.

FIG. 13 is a graph showing toxicity of foliar applications of nickel to pecan trees. Toxicity was based on a single foliar spray of nickel sulfate hexahydrate to the point of soaking of the foliage of young pecan trees. Data are 3 replicates. Toxicity rating is 1=no change, 2=marginal leaf bum, 3=2+interveinal burning.

FIG. 14 is a graph showing toxicity of foliar application of nickel sulfate hexahydrate to tomato plants. Toxicity is based on a single foliar spray to the point of soaking of the foliage of young tomato plants. Toxicity rating is: 1=no damage, 2=marginal chlorosis, 3=2+interveinal darkening, 4=3+necrosis.

FIG. 15 is a graph showing spring nickel deficiency rating of pecan after October foliar application of about 100 ppm or about 100 mg·L⁻¹ of nickel from Ni-Alyssum extract, Ni-lignosulfonate, Ni-gluconate, Ni-sulfate hexahydrate, and control. The bars for each source indicate number of replicates.

FIG. 16 is a graph showing nickel deficiency rating of pecan after post-bud break foliar application of about 100 ppm or about 100 mg·L⁻¹ of nickel from Ni-Alyssum extract, Ni-lignosulfonate, Ni-gluconate, Ni-sulfate hexahydrate, and control. The bars for each source indicate number of replicates.

FIG. 17 is a graph showing the amount of nickel found in the foliage of Indian Mustard plants seven days after treatment with a foliar application of 5 different sources of nickel applied at concentrations of about 135 ppm or about 135 mg·L⁻¹. The nickel compounds were Alyssum extract, glucoheptonate, Complex R-a lignosulfonate, Complex M-a lignosulfonate, and nickel sulfate hexahydrate.

FIG. 18 is a graph showing the amount of nickel absorbed by Indian Mustard foliage seven days after a foliar application of 3 nickel compounds applied at 6 concentrations. The nickel compounds were Ni-Alyssum extract, Complex M-a nickel lignosulfonate, and Nickel sulfate hexahydrate applied at about 0, 25, 50, 100, 150, 200, and 350 ppm or about 0, 25, 50, 100, 150, 200, and 350 mg·L⁻¹.

### DETAILED DESCRIPTION OF THE INVENTION

The inventors have discovered that nickel deficiency is common in field horticulture, a fact previously thought by the scientific community to be impossible due to the relative high amounts of nickel in essentially all soils and the exceedingly low amount of nickel needed to meet plant growth and developmental requirements. Nickel is an essential plant nutrient element in higher plants (Eskew et al., Science, volume 222, 691-693, 1983; Brown et al., Plant Physiol., Volume 85, 801-803, 1987). It is recognized as being important in the cultivation of parsley (Petroselinum crispum) (Atta-Aly, Scientia Horticulturae, Volume 82, 9-24, 1999) and of potential importance in grains (Brown et al., Plant and Soil, Volume 125, 19-27, 1990), legumes (Eskew et al., 1983 supra; Eskew et al., Plant Physiol., Volume 76, 691-693, 1984) and cucurbits (Watanabe and Shimada, Transactions 14^{th} International Congress of Soil Sci., Kyota, Japan, Volume 4, 146-151, 1990); beneficial for growth of potato (Solanum tuberosum) (Roach and Barklay, Nature (London) Volume 157, 696, 1946), grape (Vitus vinifera) (Dobrolyubskii and Slavvo, Dokl. Akad. Nauk., SSSR, Volume 112, 347-359, 1957) and soybean (Glycine max) (Bertrand and de Wolf, C. R. Acad. Sci. Ser., Volume 267, 2325-2326, 1973), but received little or no attention in tree crops.

Nickel appears to be an essential micronutrient required in the least amount by plants. It has been discovered by the inventors that the uptake of nickel is directly inhibited by excessive zinc and copper and indirectly inhibited by excessive nitrate-nitrogen, calcium, and magnesium. Furthermore, nickel is overlooked in plant nutrition management. Therefore, nickel deficiencies are far more common in potted woody plants and orchard trees than is recognized. Such deficiencies are most likely to occur as a result of excessive fertilization with other metals or with nitrogen. The inventors have discovered that a combination of the following symptoms—dwarfing, delayed bud break, blunted foliage, necrotic zones at the tip of leaves or leaflets, brittle shoots and branches, loss of apical dominance, rosetting, crinkled leaf or leaflet margins, slightly chlorotic foliage that later turns dark green, reduced growth, short internodes, dead roots, reduced flowering, shoot and tree death, can be caused by nickel deficiencies.

With mouse-ear in pecans, the inventors have observed that soil applied copper at time of transplanting corrects mouse-ear on one 2^{nd} generation site. Trees exhibiting mild to moderate mouse-ear growing on a 1^{st} generation site were largely cured of mouse-ear by the 3^{rd} year after topical application of copper to the soil; however, foliar applications of copper generally had little or no curative influence on mouse-ear severity. Neither foliar or soil application of copper to severely mouse-eared trees were efficacious for reducing symptoms. The inventors also noted that on a 1^{st} generation orchard site, soil application of high amounts of phosphorus or sulfur corrected mouse-ear symptoms three years after application. It was also noted that there is a strong statistical linkage between copper and zinc in regards to mouse-ear severity, thus implicating a zinc-induced temporary deficiency of copper as a likely causal factor of mouse-ear but these findings did not exclude deficiencies of other divalent metallic cations such as nickel, titanium, or vanadium as being involved in mouse-ear. The inventors then discovered that the copper and phosphorus source contained nickel as a trace contaminant. It was also discovered that the sulfur likely acidified the soil enough to allow for increased nickel uptake by roots.

The inventors observed a strong relationship between mouse-ear severity and soil zinc content, thus implicating zinc as a contributing factor to mouse-ear. Because zinc, copper, and nickel ion uptake from soils by feeder roots appear to share the same ion channels for entry into the root vascular system (Kochian, In: Micronutrients in Agriculture, 2^{nd} Edition, Soil Sci. Soc. Amer., Inc. Madison, Wis., 229-296, 1991), it became apparent that mouse-ear is caused by either a nickel or copper deficiency that is being induced by excessive zinc on 2^{nd} generation sites and by low soil nickel or copper on 1^{st} generation sites.

Inorganic and organic sources of nickel correct acute and chronic nickel deficiencies. Examples of useful organic sources of nickel include nickel lignosulfonate, water extract of any nickel accumulating plant or plants used in phytoextraction of nickel from mineralized or contaminated soils such as, for example, Alyssum, nickel gluconate, nickel sulfamate tetrahydrate, nickel acetate tetrahydrate, anhydrous nickel salts, hydrated nickel sulfate, hydrated nickel nitrate, hydrated nickel chloride, and mixtures thereof;. Examples of useful inorganic sources of nickel include nickel sulfate hexahydrate, nickel chloride hexahydrate, nickel nitrate hexahydrate, and mixtures thereof. The nickel source is applied in an amount effective to at least reduce the severity of the abnormality caused by a nickel deficiency. For purposes of the present invention, the term “effective amount” or “amount effective for” as used herein means that minimum amount of nickel needed to at least reduce the severity of the nickel deficiency-induced growth disorder. Furthermore, the effective amount used does not cause phytotoxicity in the plant. The units for the concentration of nickel applied as a spray are in ppm or mg·L⁻¹. The minimum concentration of nickel needed to correct acute nickel deficiencies is between about 1 ppm to about 20 ppm or about 1 mg·L⁻¹ to about 20 mg·L⁻¹, with about 10 ppm or about 10 mg·L⁻¹ being the preferred lower limit concentration for a foliar spray and about 2-20 ppm Nickel for a soiless medium amendment. The maximum concentration of nickel needed to correct acute and chronic nickel deficiency is between about 11 ppm or about 11 mg·L⁻¹ to about 150 ppm or about 150 mg·L⁻¹, with about 25-100 ppm or about 25-100 mg·L⁻¹ preferred. The phytoxicity point for nickel foliar spray applications to sensitive foliage is a foliar spray solution containing a nickel concentration of about 200 ppm or about 200 mg·L⁻¹ to about 400 ppm or 400 mg·L⁻¹. In one embodiment of the present invention, the nickel is formulated in a foliar spray which includes water and any nonionic surfactant which is does not interfere with nickel absorption by the leaves and is not toxic to the plants to which it is applied. Examples of useful nonionic surfactants include, but are not limited to are: poly alkyl aryl ethers, polyoxyethylene alkyl ethers, polyoxyethylene alkyl amine ethers, polyoxyethylene alkyl esters, polyoxyethylene castor oil derivatives, polyethylene glycols, EO/PO copolymers, Tweens, sorbitan fatty acid esters, amine oxides, polyethylene glycol esters, etc. The exemplified nonionic surfactant is BioSurf (Platte Chemical Company, Fremont, Nebr.), an alkyl polyoxyethylene plus fatty acid mix. The foliar spray containing nickel is sprayed onto plant organs, usually foliage, to thoroughly coat the foliage to the point of spray run-off; although spray coverage less than that of run-off is sufficient to correct deficiency symptoms. The amount applied as foliar sprays range from about 0.38 g/acre or about 0.38 grams/100 gallons of spray mix to about 57.0 grams Ni/acre or about 57 grams/100 gallons of spray mix. Application is typically performed within the first few weeks after bud break or during the last few weeks prior to autumn leaf-fall. In certain situations, Ni can be applied to the soil or orchard, field, or vineyard floor to correct symptoms. In such cases, Ni is applied at about 5 kg of nickel per hectare or less.

In another embodiment of the present invention, the organic form of nickel is applied to plants by incorporating the biomass of at least one nickel accumulating plant into a soiless potting medium. The amount of biomass added to a soiless potting medium should be an amount which provides about 2 ppm to about 20 ppm Nickel. The rate of biomass incorporated in a soiless potting medium is about 0.01% to abut 1.0% by weight. This provides a slow release, long term source of nickel for potted plants, such as for example, river birch. For purposes of the present invention a soiless potting medium is defined as containing at least one source of organic matter such as for example peat moss, pine bark, etc.; and at least one source of an inorganic material such as sand, perlite, vermiculite, compost, etc. For purposes of the present invention biomass is defined as a nickel accumulating plant material that is grown to extract nickel from soil, harvested, dried, and ground or pulverized to a consistency of coarse sand in order to be uniformly mixed with a soiless potting medium. Examples of nickel accumulating plants include species of Alyssum. See U.S. Pat. No. 5,711,784, issued Jan. 27, 1998 and U.S. Pat. No. 5,944,872, issued Aug. 31, 1999 and both herein incorporated by reference.

Plants treatable by the present invention include, for example, any plant exhibiting a nickel deficiency disorder such as, for example, replant disorder, blunted foliage, little leaf, mouse-ear, etc. Nickel deficiency is diagnosed in plants by blunting of young foliage, i.e., the leaf or leaflet tips, due to urea toxicity in the young expanding tissues; dwarfing, delayed bud break, necrotic zones at tip of leaves or leaflets, brittle shoots and branches, loss of apical dominance, resetting, crinkle leaf or leaflet margins, slightly chlorotic foliage that later turns dark green, reduced growth, short internodes, dying shoots, and reduced flowering. Other plants known to exhibit nickel deficiency include, for example, River Birch, Plums, Peaches, Nectarines, Apple, Pear, Almond, Walnut, Pistachio, Grapes, Prunus spp., Citrus spp. and, woody ornamentals grown in containers such as, for example, Pyracantha spp., Acer spp., Alnus spp., Betula spp., Carpinus spp., Carya spp., Cereis spp., Cornus spp., Euonymus spp., Fraxinus spp., Hibiscus spp., Hydrangea spp., Juglans spp., Malus spp., Quercus spp., Salix spp., Tilia spp., Populus spp., spp., Viburnum spp. etc. It is noteworthy that both pecan and river birch are hydrophilic species (e.g. adapted to a moist environment) and that both transport nitrogen via ureides. Many hydrophilic and tropical legume species transport substantial nitrogen as ureides rather than amides or amino acids. Ureides are structurally related to urea and some represented examples are allantoin, allantoic acid, citrulline, uric acid, hypoxanthine, xanthine, daffeine, hydroxycitrulline, and albizzine. Such compounds play an important role in the assimilation, metabolism, transport, and storage of nitrogen in many hydrophilic species. It has been suggested that urease plays a role in ureide catabolism (Polacco et al., 1985, in Schubert and Boland, The Biochemistry of Plants, Volume 16, 197-282, 1990) and urease activity is dependent on Ni (Dixon et al., Journal of the American Chemical Society, Volume 97, 4131-4133, 1975). This background is evidence that species most likely to display Ni deficiencies in field or nursery situations are hydrophiles and/or ureide transporters. Examples of ureide transporting genera are Acer, Alnus, Annona, Betula, Carpinus, Carya, Cercis, Chamaecyparis, Cornus, Corylus, Diospyros, Juglans, Nothofagus, Ostrya, Platanus, Populus, Pterocarya, Salix, and Vitus (Schubert and Boland, 1990, supra). These genera represent only a partial list of woody perennial candidates, but include several major crops in which Ni deficiency might be most likely found. These include orchard and vineyard crops of pecan, the several walnut species, grape, persimmon, and filberts; plus a multitude of landscape and ornamental crops. Many tropical legumes are also ureide transporters and are also likely candidates for Ni deficiency. Replant disorder is a disorder due to insufficient nickel uptake by plants due to excessive accumulation of competing metals in the soil such as for example, non-competitive inhibitors of nickel uptake including calcium and magnesium, and competitive inhibitors of nickel uptake including zinc, copper, iron, and manganese for example, which is typically due to excessive fertilization over many decades.

The following examples are intended only to further illustrate the invention and are not intended to limit the scope of the invention which is defined by the claims. Pecan trees exhibiting mouse-ear are used as a model plant for plants with growth disorders due to nickel deficiencies.

For the following examples, several mouse-ear affected pecan trees were studied in commercial orchards throughout the Gulf Coast Coastal Plain of Georgia, United States. Soil types among affected orchards differ substantially, but were almost always either sandy loams or some sort of sands. Most mouse-ear affected trees were found on sites previously supporting pecan orchards, or were replacement trees in existing mature orchards. Mouse-ear affected trees sometimes occurred on sites where pecan had not previously been grown. Most of the affected cultivars were either ‘Desirable’ or ‘Sumner’, but also included ‘Elliott’ and ‘Cape Fear’, which are among the most commonly replanted cultivars in the southeastern United States. The rootstocks for these trees are unknown, but are likely either ‘Curtis’ or ‘Elliott’ seedlings.

### EXAMPLE 1

Tree organs and tissues were visually classified regarding mouse-ear associated symptoms during early spring and midsummer of several years so as to identify specific symptoms. Affected trees were categorized according to degree of severity of mouse-ear symptoms. Two mouse-ear based tree classes were studied: no mouse-ear symptoms versus severe mouse-ear. Trees of the two classes were randomly selected from five affected orchards. Ten trees of each treatment category in each orchard were evaluated for trunk caliper, tree height, leaf area per shoot, nodes per shoot, shoot length, leaves per shoot, leaflets per leaf, and catkin length.

The root system of affected trees was evaluated by visual examination of lateral roots of pairs of 16 adjacent trees, with one exhibiting severe mouse-ear and the other free of symptoms. Roots were excavated within the uppermost 20 cm of the soil profile. Roots positioned on both the west and east side of the tree, but beneath the canopy, were measured for number of living secondary roots, i.e., the number of live laterals per 25 cm of root less than 4 mm in diameter. Data were analyzed by ANOVA using SAS (SAS Institute Inc., 1990).

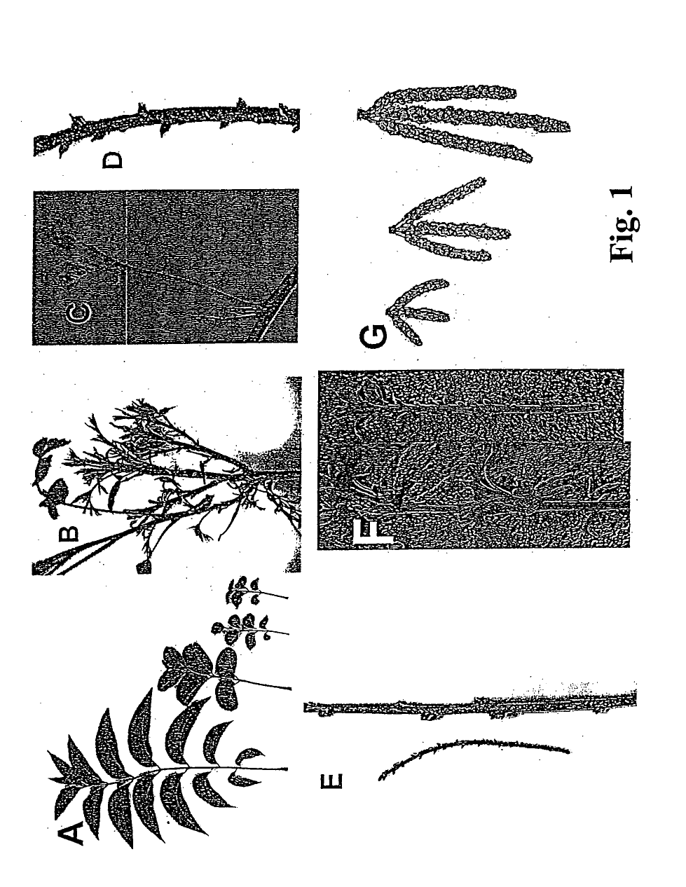

Previously published reports describing the symptoms of mouse-ear have noted the mouse-ear-like distortion of foliage and dwarfed leaflets and leaves, but not other morphological symptoms exhibited by severely affected mouse-ear trees (Gallaher and Jones, Journal Amer. Soc. Hort. Sci., Volume 101, 692-696, 1976; Grauke et al., 1983, supra; and Worley, HortScience, Volume 14, 51-52, 1979). Several distinct symptoms of the severe form of mouse-ear are illustrated in FIGS. 1A-1G.

FIG. 1A illustrates some of the most common morphs expressed by mouse-ear foliage. Compound leaves and leaflets can be reduced in size to less than about 1% of normal foliage. Moderate to severe mouse-ear typically exhibits some degree of rosetting at shoot tips (FIG. 1B). Rosetting sometimes results after death of the terminal bud, but also commonly occurs without terminal bud death. In severe cases, primary, secondary, and tertiary buds simultaneously break at shoot nodes (FIG. 1C). Shoots are usually dwarfed, spindly, brittle, and have abnormally elongated and pointed buds (FIG. 1D). Mouse-ear shoots have shorter internodes, but a similar number of nodes compared to normal shoots, causing affected shoots to be dwarfed (FIG. 1E). Shoots also exhibit delayed bud break (FIG. 1F), up to three weeks. Catkins are also substantially reduced in length and often display necrotic tips (FIG. 1G).

Other symptoms associated with severe mouse-ear that have not been previously reported include: (a) necrosis of the apical tips of leaflets; (b) a small zone adjacent to this necrotic region that is dark green during the early stages of mouse-ear; (c) leaflets that are more chlorotic during the first few weeks after bud break than normal leaves of equal age, but usually becoming equally green by mid-summer; (d) the base of the petiole of the compound leaf of affected leaves often exhibits a distortion of growth to produce a wing-like protrusion along both sides of the basal section of the petiole; (e) leaflet margins are curled and the lamina is wrinkled and brittle; (f) shoots often die during the dormant season, thus giving the appearance of cold injury; (g) trees are dwarfed; (h) there are few catkins on affected shoots and almost no pistillate flowers, (i) in the most severe cases the lamina of leaflets fails to form and the associated emerging shoot dies; (j) the root system of severely affected trees is reduced, exhibiting relatively few feeder and lateral roots-a similar reduction in root growth by mouse-ear trees was reported by Grauke et al. (1983, supra) for potted seedling trees; and (k)tree death which is estimated to occur in about 0.5% of all mouse-ear cases.

18-year-old ‘Desirable’ trees that exhibited severe mouse-ear had several significant growth differences compared to normal trees (Table 1 below). Mouse-eared trees were about one-third the height and caliper of adjacent normal trees (Table 1). Shoots of mouse-ear trees had about 11% of the leaf area on affected shoots as did normal trees, although the number of leaves per shoot and leaflets per compound leaf were equal. Mouse-eared shoots were about 26% the normal shoot length but did not differ in the number of nodes per shoot. Average catkin length was about 67% that of normal catkins. Mouse-eared trees also exhibited only about 19% as many living roots branching from primary lateral roots. Excavated root systems of mouse-ear affected trees typically exhibited considerable numbers of dead roots-greater than 75% dead roots of the most severe cases of mouse-ear. Thus, mouse-eared trees were generally dwarfed and had impaired root system of fewer living lateral roots per tree.

TABLE 1
Influence of mouse-ear on morphological and growth characteristics of ‘Desirable’ pecan trees.

| | | | | | | | | | Live Lateral |
|---|---|---|---|---|---|---|---|---|---|
| | Tree | Tree | Shoot | Shoot | Nodes | Leaves | Leaflets | Catkin | Roots per |
| Tree | Height | Caliper | Leaf Area | Length | Per Shoot | Per Shoot | Per Leaf | Length | decimeter |
| Status | (m) | (cm) | (cm²) | (cm) | (no.) | (no.) | (no.) | (cm) | (no.) |
| Normal | 6.2 | 27.5 | 1,620 | 81 | 31 | 9 | 11 | 9 | 6 |
| ME | 2.4 | 9.5 | 178 | 21 | 29 | 9 | 11 | 6 | 1 |
| Significance^{z} | | * | * | * | NS | NS | NS | * | |

^{z}* = significantly different by ANOVA at P = 0.05 level.

### EXAMPLE 2

Mouse-ear shoots were collected in early March, stored under refrigeration, and then grafted onto normal trees in early April. The graftwood was collected from six severely affected trees and grafted onto six normal trees via inlay bark grafts. Regrowth of grafts was then evaluated for mouse-ear symptoms as the shoots and leaves developed. Adjacent mouse-ear affected shoots on trees from which the graftwood was obtained were observed for manifestation of mouse-ear so as to ensure the graft shoots were indeed mouse-ear disposed.

When shoots exhibiting severe mouse-ear symptoms were grafted to normal trees, the developing organs of the graft on the stock never exhibited mouse-ear symptoms (data not shown) whereas adjacent shoots on the donor trees always showed mouse-ear the next spring. These grafts did not revert to exhibit mouse-ear symptoms within three years of grafting, nor did symptoms appear on other portions of the stock. Thus, mouse-ear was not transmitted via grafting and was rapidly and totally cured with access to the vascular system of the healthy host tree.

This response is evidence that mouse-ear is not due to a shoot associated infection of a biological agent, such as a virus, bacterium, mycoplasma, or fungus. Exposure of the host tree's vascular system appears to have provided one or more factors that enabled predisposed mouse-ear buds to grow normally.

These results indicate that the proposed micronutrient deficiency within the buds of the mouse-ear grafts was corrected at, or soon after, the time of bud break. This is consistent with the hypothesis that severe mouse-ear is caused by a localized physiological deficiency of one or more micronutrients at the time of bud break.

### EXAMPLE 3

The spatial distribution of mouse-ear was visually assessed as related to position within the canopy. Positional differences were assessed according to the condition of the five shoots displaying the most severe degree of mouse-ear within a designated vertical zone of the tree from lowest to highest, about 0-20%, 21-40%, 41-60%, 61-80% and 81-100%. Severity classes were: 1=no mouse-ear; 2=trace, <1% of foliage being distorted; 3=slight 1-10% of foliage being distorted; 4=moderate, 11-50% being distorted; 5=heavy, 51-100% being distorted; 6=very heavy, 100% leaf distortion but no resetting; 7=severe, rosetting. Evaluations were based on 5 affected ‘Desirable’ trees between 4 and 12 meters tall. Trees were from within a single orchard.

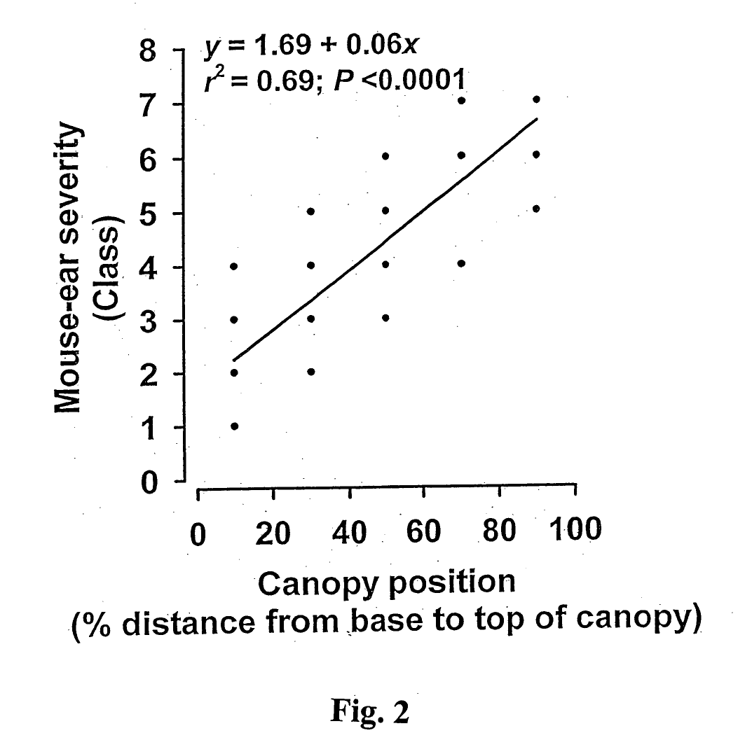

In the case of young trees exhibiting only a slight amount of mouse-ear-like distortions in leaf morphology, the distortion appears at random within the canopy. It can be associated with a pair of leaflets, a single compound leaf, a single shoot, or a single limb. However, in the case of moderate to severe mouse-ear, foliar symptoms consistently vary in degree of severity according to canopy position. Graduations in degree of severity within trees of the above described study was such that severity class of mouse-ear symptoms increased linearly (y=2.21+0.87x; P<0.0001, r²=0.60) with distance of canopy from the orchard floor (FIG. 2). Foliage and shoots of the upper canopy of moderate to severely affected trees ranged from heavy to severe in the upper about 20% of the canopy, whereas the lower about 20% exhibited only slight to moderate severity. A linear (y=6.60-0.53x; P<0.0001, r²=0.65) gradient in severity is also evident in the compound leaves on affected shoots, in that severity is typically most pronounced on the basal compound leaves of shoots (data not shown). The apical compound leaf often exhibits only moderate to slight mouse-ear distortions in shape of associated leaflets whereas the basal-most leaves exhibit moderate to severe mouse-ear. Similarly, the basal-most leaflet pairs of each compound leaf tends to exhibit a much greater severity of distorted leaflets than apical-most leaflet pairs (FIG. 1A).

The above described gradient in severity of mouse-ear within canopy, shoots, and compound leaves indicate that the symptom was associated with a deficiency of some factor, presumably one or more micronutrients, that was limiting at the time of bud break and during the early stages of shoot and foliage development, but became non-limiting or less limiting within a few days or weeks after initiation of shoot and foliar growth. This indicates that the factor(s) is not stored in sufficient quantities from the previous growing season; thus, failing to satisfy demands associated with following spring's shoot and leaves. Thus, the factor(s) does not translocate in sufficient quantity from senescent foliage into bud or shoot storage pools for next season's growth process.

### EXAMPLE 4

About 35 ‘Desirable” trees were pruned by farmers at two orchards exhibiting severe mouse-ear. Trees were drip irrigated and commercially managed. Pruning was done during the dormant season by cutting several limbs back to 50% of their original length, but not all limbs within the trees were pruned. The severity of mouse-ear was observed on the pruned and non-pruned branches of trees the following 1-3 years, depending upon the orchard.

Pruned limbs of severely mouse-ear affected trees broke bud from about 1-3 weeks later than did buds from nonpruned trees (anecdotal observation only). Shoots and foliage produced the first growing season after pruning exhibited little or no mouse-ear whereas the non-pruned limbs exhibited substantial levels of mouse-ear. However, growth from the pruned limbs the second and third year after pruning once again exhibited severe mouse-ear similar to that exhibited on non-pruned limbs. Thus, pruned trees eventually revert to displaying mouse-ear.

This anecdotal observation is consistent with the results from the above described grafting study in that buds breaking later than normal in the spring show little or no mouse-ear symptoms. The same effect was also noted for second-cycle shoots breaking bud in August, i.e., no mouse-ear was ever visible on late season shoots. It is also noteworthy that when mouse-ear is so severe that the primary buds die, or the resulting shoots abort soon after bud break, the resulting secondary or tertiary buds result in normal or near normal shoot and foliar growth and development. This indicates that the limiting factor(s) has become non-limiting, or nearly so at least at the acute level, by the time of this secondary phase of bud break.

### EXAMPLE 5

Gas exchange activities of foliage were compared in July on fully expanded leaves of 8 mouse-ear trees and 8 adjacent normal trees. Gas exchange measurements were photoassimilation (A), stomatal conductance (Sgw), and transpiration (E). Measurements were made using a LI-COR 6400 Photosynthetic System (Lincoln, Nebr.) on leaflets occupying the same relative position on the compound leaf and shoot of each of the two treatments. Sampled shoots were from the exterior and lower southern exposed portion of the canopy. Measurements on the mouse-ear affected trees were from leaflets displaying heavy mouse-ear symptoms (Class 5 severity; as described above). The same leaflets were measured during mid-morning and again in mid-afternoon. Experimental design was a randomized complete block (8 blocks) with two mouse-ear treatments and two time-of-day treatments. Gas exchange treatments were made during mid-morning and mid-afternoon at about 1,800 μmol's·⁻¹·m⁻² photosynthetically active radiation according to previously reported methods for pecans (Wood et al., J. Amer. Soc. Hort. Sci., Volume 125, 41-46, 2000; herein incorporated by reference). Leaf water potential was measured, on leaves at the same positions as described above, using a Scholander pressure bomb. Data were analyzed using SAS (SAS Institute, Inc., 1990).

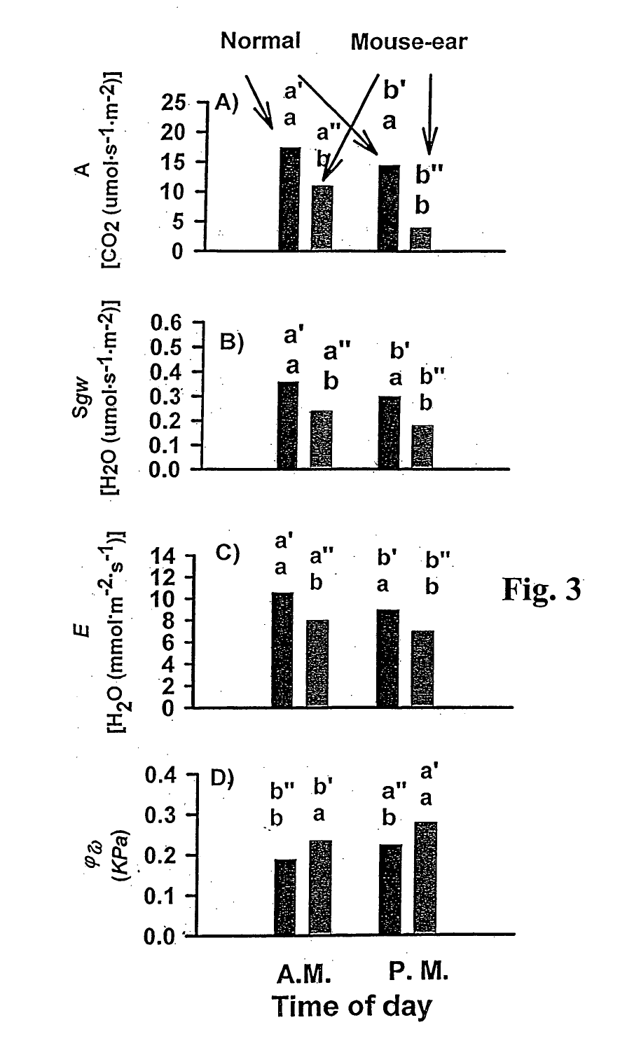

Mouse-ear affected trees differed from adjacent normal trees in rate of gas exchange for both CO₂ and H₂O (FIG. 3). The rate of photassimilation (A) for similar leaflets, between mouse-ear and control trees, was affected by both mouse-ear and time of day (FIG. 3A). Based on equivalent leaf areas, mouse-ear affected leaflets were only about 63% as productive during mid-morning hours as were unaffected leaflets. During the afternoon hours, mouse-ear affected leaves were only about 20% as productive as were unaffected leaflets. Both mouse-ear and unaffected leaflets exhibited substantially lower photoassimilation (A) in the afternoon as compared to mid-morning. Mouse-ear and time-of-day treatments interacted to result in the percentage of reduction in the afternoon being greater for the mouse-ear trees than for the unaffected trees with about 79% of morning rates for the unaffected trees and 32% for the mouse-ear trees. Stomatal conductance (Sgw) of similar leaflets of mouse-ear trees was only about 68% of the control at either mid-morning or mid-afternoon (FIG. 3B). Stomatal conductance (Sgw) for both treatments was less during the afternoon than in mid-morning.

Although leaflet color was not measured, visual observation clearly indicated that affected leaflets, as compared to unaffected leaflets, are initially more yellowish green within about the first 2 to 6 weeks after bud break and become darker green by mid. June to July. In certain cases, severely affected foliage can appear to be darker green than do normal foliage when viewed in mid- to late-summer. The above described measurements of gas exchange were done when mouse-ear affected foliage did not appear to differ in color from normal foliage.

Mouse-ear affected trees also differed from adjacent unaffected trees in water relations characteristics. Transpiration (E) was greater in unaffected than in mouse-ear affected foliage, with transpiration (E) being greater in the afternoon than in the morning (FIG. 3C). Leaf water potential also differed between the mouse-ear and the unaffected leaves (FIG. 3D) in the afternoon. Mouse-ear affected foliage exhibited higher Ψω than did unaffected leaves in the afternoon but not in the morning. Afternoon Ψω was greater than morning Ψω for both unaffected and mouse-ear leaves.

These measurements of CO₂ and H₂O exchange rates and Ψω indicate the mouse-ear affected trees exhibit reduced rates of net photosynthesis and are also under greater water stress than normal trees. This likely contributes to the reduced-tree height, trunk diameter, and shoot length typical of severely affected trees (Table 1 above).

### EXAMPLE 6

Determination of differences in nutrient element concentrations among mouse-ear and unaffected leaflets within the same tree were studied. Mouse-ear affected foliage was visually classified according to one of the six categories based on severity as described above in Example 3. Five trees were sampled in late April. All leaflets were removed from petioles of about 20 compound leaves reflecting each severity class. Leaflets were assessed for fresh weight, leaf area, dried at about 55° C., ground to pass a 20-mesh screen, and subjected to elemental analysis using standard techniques. Nutrient element concentrations were regressed against mouse-ear severity using PROC-REG in SAS. Individual linear and multiple regressions were calculated. A stepwise procedure was used for model selection. Nutrient elements were compared on a gram-atom basis so as to provide greater resolution of how elements compare to each other.

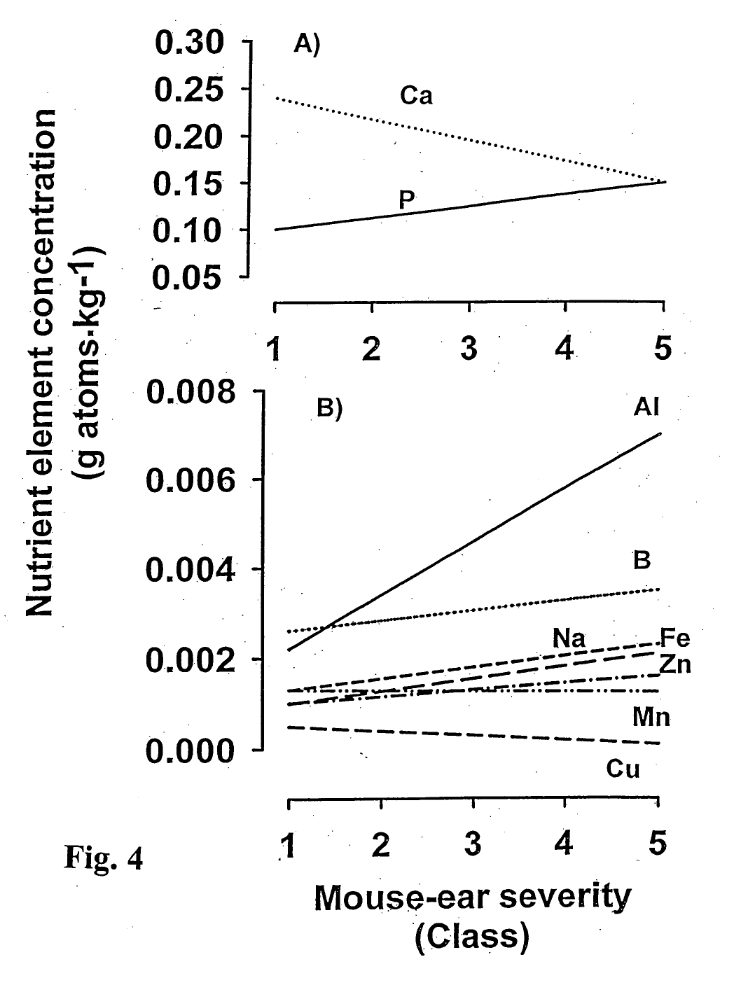

The level of several macro- and micronutrients in late April leaflets varied with mouse-ear severity class (FIG. 4). Linear regression analysis of gram-atom leaf elemental concentration s against severity level of mouse-ear, indicated increases in severity as P(r²=0.61), Al (r²=0.72), Zn (r²=0.68), Fe (r²=0.84), Na (r²=0.39), and B (r²=0.62) increased; and an inverse relationship with Ca (r²=0.54) and Cu (r²=0.48). The associations with N, K, Mg, Fe, and Mn exhibited r² values less than 0.35 and were not significant at P<0.05. The best stepwise multiple linear regression model was: Mouse-ear rating=−7.39+24*P+1,979*B+981*Na, R²=0.96; with Fe being added first, P second, B third, Na fourth, and Fe removed in the presence of the other three. This indicates that there are major changes in levels of certain nutrients as severity of mouse-ear increases. Levels of P, B, and Na possess the greatest predictive power.

Although there was no detectable relationship between the severity of mouse-ear and most of the measured micronutrients, these data do not exclude the possibility that one or more micronutrients are in the foliage at insufficient levels, and are physiologically limiting due to being tied up in unavailable organic complexes. These results are still consistent with the hypothesis that mouse-ear is due to a localized physiological deficiency of one or more micronutrients at the time of bud break, but suggests that this deficiency may be associated with the micronutrient(s) being tied up in physiologically unavailable forms rather than a deficiency in the absolute amount of the micronutrient(s).

### EXAMPLE 7

Soils were tested for macro- and micronutrient concentrations, cation exchange capacity, and pH, from 15 Georgia orchards in which transplants exhibited severe mouse-ear. Soil was sampled from the top about 18 cm of the soil profile beneath affected trees. Orchards were segregated into three distinct classes; (a) first generation orchards which are orchards which had never been planted with pecan trees before showing mouse-ear; (b) second generation orchards with trees growing where there had previously been a pecan orchard or those situated where a large pecan tree has previously grown showing mouse-ear, and (c) first generation orchards of young trees not showing mouse-ear symptoms, but adjacent to a second generation orchard showing symptoms in new transplants. The three orchard types were compared for statistical differences in nutrient elements by the Satterthwaite t-test (SAS Institute, 1990).

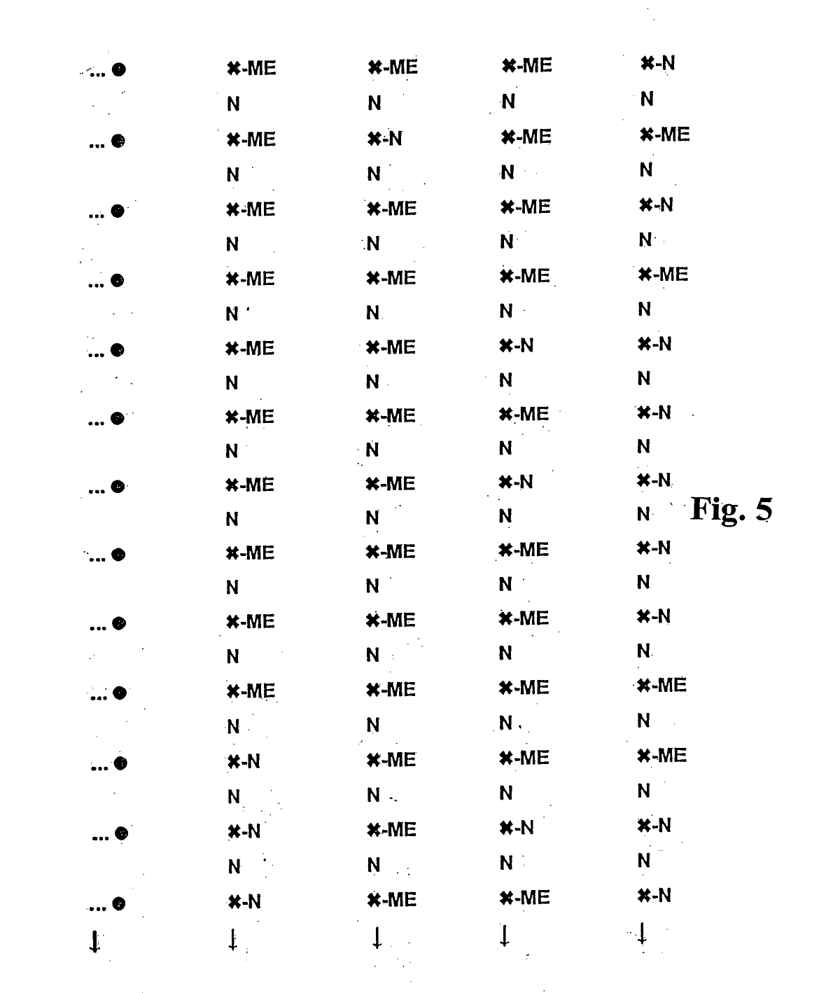

The rating for incidence of mouse-ear was done on trees of a 5-year-old drip irrigated ‘Desirable’ orchard planted on a site that previously had approximately 80-year-old ‘Success’ trees. The previous ‘Success’ orchard had been commercially managed for several decades and had annually received soil fertilization and multiple annual foliar Zn sprays as recommended by Georgia Extension Service guidelines. The old ‘Success’ trees, planted on about a 18.3 m×18.3 m spacing, were removed and new ‘Desirable’ trees (rootstock unknown) were transplanted at the exact positions of the previous tree as well as between previous tree sites (but in direction only) giving about a 18.3 m×9.15 m spacing. Transplanted ‘Desirable’ trees began exhibiting mouse-ear symptoms with blunted foliage or rosetting the second and third year after planting. All trees were visually rated for mouse-ear symptoms during the sixth growing season. They were then mapped in relation to pre-existing trees (FIG. 5). Soil characteristics were then compared at sites between previously existing older trees. Soils at the two sites were sampled from about 0-20 cm depths with a soil probe, with 10 subsamples bulked for each 10 tress for each category. The experimental design consisted of two mouse-ear treatments and 10 replicates. Soil at the location of 10 mouse-ear trees, beyond the auger hole but within the canopy zone, was sampled at about 0-3 cm, 3.1-6 cm, 6.1-9 cm, 9.1-15 cm, and 15.1-20 cm depths for measurement of soil characteristics.

Soils supporting trees exhibiting severe mouse-ear were acidic with pH ranging from about 5.2 to about 6.9, had low cation exchange capacity of about 4.4 to about 12.5 meq/100 grams, and soils were sandy textured, i.e., loamy sand or sandy loam (Table 2 below). First generation orchards exhibiting mouse-ear had higher amounts of soil P and Zn, but did not differ in pH, cation exchange capacity, K, Mg, Ca, Mn, Fe, Cu, B, Ni, Co, or Sn, than first generation orchards that did not exhibit mouse-ear and were adjacent to second generation orchards exhibiting mouse-ear (Table 2). Similarly, second generation orchards exhibiting mouse-ear had higher amounts of soil P, Mn, Fe, Zn, Cu, Ni, and Sn, but did not differ in pH, cation exchange capacity, K, Mg, Ca, B, or Co, than first generation orchards that did not exhibit mouse-ear and were adjacent to second generation orchards exhibiting mouse-ear (Table 2). First generation orchard sites exhibiting mouse-ear had less Mn, Zn, Cu, Ni, and Sn, than second generation sites showing mouse-ear. Thus, higher P and Zn levels are evident in soils of orchards that exhibit mouse-ear and second generation orchard soils appear to have accumulated Zn, Mn, Cu, Ni, and Sn over decades of orchard management for nutritional and disease control issues. Soil test reports for second generation orchards almost always classified P, Ca, Mg, and Zn amounts as very high.

When these three types of orchards were compared with regards to ratios of certain micronutrients to copper, it was found that the soil Zn:Cu ratio (g-atoms per unit of cation exchange capacity) of the soil was about 16-17 fold greater in the two types of mouse-ear affected orchards as compared to adjacent non-mouse-ear orchard soils (Table 3 below). There were no differences in the Co:Cu, Mn:Cu, and Zn:Cu ratios. Second generation orchards possessing mouse-ear also had a Ni:Cu ratio of about 9-fold that of first generation mouse-ear orchards. Similarly, the Zn:Ni ratio in these three orchards was such that there was about 182 times as much zinc as nickel in the first generation mouse-eared orchard and about 47 times more in the second generation mouse-eared orchard (Table 3). These observations provide additional evidence that possibly low soil copper and/or nickel may be a key cause of the severe form of mouse-ear which may be exacerbated by high soil zinc.

The occurrence of mouse-ear in trees planted where a tree previously grew is illustrated in FIG. 5. Of 152 ‘Desirable’ trees assessed in this second generation orchard, about 64 trees exhibited mouse-ear symptoms. Of those exhibiting mouse-ear symptoms, about 63 trees were on the exact sites of previous ‘Success’ trees and only one was growing at a location between pre-existing trees. Thus, about 84% of all trees planted on the old site exhibited mouse-ear whereas about 1% of those planted between old sites exhibited mouse-ear. These data clearly illustrate a strong relationship between mouse-ear and the soil environment associated with previous trees. This characteristic of abnormal growth after replanting in previous sites supporting trees is typical of many replant disorders found in other trees and vine crops. Soil characteristics were compared for locations within the same orchard that supported mouse-ear trees where the 80-year-old ‘Success’ trees were previously grown, and those not exhibiting mouse-ear which were planted mid-way between where 80-year-old ‘Success’ trees previously grew (Table 4 below). Soil nutrient differences between the two sites were a 2-fold greater amount of zinc where there was mouse-ear, plus slightly greater levels of Mn, Ni, and Sn. Soil copper was low at both orchard locations. A similar, but less dramatic linkage is common when mouse-ear is exhibited by transplants in existing orchards. Thus, under certain conditions, mouse-ear is clearly a transplant problem. When the root system of these trees is excavated and examined, there is often an abundance of dead or dying small roots. These roots often show galling by root-knot nematodes and many with no-root nematode damage. Mouse-ear trees in this replant disorder orchard were treated and cured by foliar applications of nickel as described in Examples 8 and 9. Thus, clearly identifying a nickel deficiency as the cause of replant disorder in pecan and identifies nickel as a likely factor in certain replant disorders found in other horticultural tree and vine crops.

TABLE 2
Comparison of soil characteristics between orchards exhibiting
mouse-ear (ME) and adjacent orchards not exhibiting mouse-ear.

| | Macronutrients | | | | | | Micronutrients | | | | | | | |
|---|---|---|---|---|---|---|---|---|---|---|---|---|---|---|
| | Kg/ha | | | | | | Kg/ha | | | | | | | |
| Orchard Type | pH | CEC^{y} | P | K | Mg | Ca | Mn | Fe | Zn | Cu | B | Ni | Co | Sn |
| 1^{st} gen. − ME | 6.2^{x}ns | 6.3ns | 95a | 174ns | 314ns | 1,215ns | 28a | 12a | 3a | 1.0a | 1.3ns | 0.26a | 0.08ns | .38a |
| 1^{st} gen. + ME | 6.4 | 8.8 | 164b | 226 | 295 | 1,929 | 28a | 21b | 48b | 0.9a | 1.0 | 0.27a | 0.16 | 0.38a |
| 2^{nd} gen + ME | 6.2 | 7.1 | 146b | 219 | 217 | 1,700 | 58b | 22b | 73c | 2.0b | 1.4 | 1.56b | 0.15 | 0.92b |

^{y}Cation exchange capacity (meq/100 gsoil)
^{x}Satterwaite t-test of treatment means. Means within a column followed by different letters are statistically different at the P ≦ 0.05 level,
ns = not different at P ≦ 0.05 level.

TABLE 3
Comparison of soil micronutrient ratios between orchards exhibiting
mouse-ear (ME) and adjacent orchards not exhibiting mouse-ear.

| Orchard Type | Zn:Cu^{y} | Ni:Cu | Co:Ca | Mn:Cu | Sn:Cu | Zn:Ni |
|---|---|---|---|---|---|---|
| 1^{st} gen − ME | 3a^{x} | 0.30a | 0.10ns | 33ns | 0.44ns | 12a |
| 1^{st} gen + ME | 47b | 0.21a | 0.06 | 36 | 0.54 | 182c |
| 2^{nd} gen + ME | 52b | 1.95b | 0.17 | 55 | 0.65 | 47b |

^{x}Satterawite t-test of treatment means. Means within a column followed by the same letter are statistically different at the P ≦ 0.05 level.
ns = not statistically different at P ≦ 0.05.
^{y}Rate of zinc to copper after adjusting for cation exchange capacity (CEC) of the soil; i.e., Kg/ha of Zn/CEC/(Kg/ha of Cu/CEC.

TABLE 4
Soil characteristics of a mouse-ear affected 2^{nd} generation ‘Desirable’ orchard planted
at the same site where an 80-year-old ‘Success’ orchard previously grew.
Concentrations are the amount in the soil at each transplant location.

| | Macronutrients | | | | | | Micronutrients | | | | | | | |
|---|---|---|---|---|---|---|---|---|---|---|---|---|---|---|
| | Kg/ha | | | | | | Kg/ha | | | | | | | |
| Transplant Location | pH | CEC^{y} | P | K | Mg | Ca | Mn | Fe | Zn | Cu | B | Ni | Co | Sn |
| Previous site | 6.1^{y} | 8.4 | 205 | 323 | 224 | 1300 | 59 | 27 | 90 | 0.5 | 1.6 | 2.2 | 0.2 | 0.8 |
| Between | 6.1 | 8.1 | 230 | 310 | 220 | 1258 | 46 | 31 | 52 | 0.6 | 1.5 | 1.7 | 0.2 | 0.6 |
| Significance | NS | NS | NS | NS | NS | NS | * | NS | * | NS | NS | * | NS | * |

^{y}* = significantly different at P ≦ 0.05 level;
NS = not significant at P ≦ 0.05 level.

### EXAMPLE 8

The ability of autumn foliar application of either copper or nickel to correct mouse-ear was evaluated in several different orchards, including the site cited in Example 7 with a clear pattern to the replant disorder. The experiment consists of three micronutrient treatments: control, copper, and nickel. The treatments were applied in October as a foliar spray to major branches of severely mouse-eared “Desirable” trees. Individual trees served as replicates comprised of all three micronutrient treatments. Treatments were spatially separated within the tree canopy so as to avoid cross-contamination of sprays. All treatments contained urea at about 4.8 grams/liter and Bio-Surf (alkyl polyoxyethylene plus fatty acids) a nonionic surfactant, at about 2.5 ml/liter as additives. The copper source was CuSO₄.5H₂O at a concentration of about 4 grams/liter. The nickel source was NiSO₄.6H₂0 at a concentration of about 3.5 grams/liter. Control treatments received only urea and surfactant. Sprays were applied to foliage till run-off. There were about 20 replications dispersed over two different orchard sites. The experiment was a RCB design comprised of three treatments with single tree blocks. Treatments were evaluated the following spring in May for severity of mouse-ear. Severity was based on the following scale:
1=no symptoms
2=between about 1 and about 25% of number of leaflets per shoot exhibiting blunting
3=between about 26 to about 50% of number of leaflets per shoot exhibiting blunting
4=greater than about 50% of number of leaflets per shoot exhibiting blunting
5=cupping of blunted leaflets
6=necrosis of leaflet
7=dark green zone leaflet tip
8=stunted shoots
9=multiple new shoots; i.e., witches broom
10=dead shoot
   Data were statistically analyzed for mean separation of treatments by use of JMP (SAS, Cary, N.C.; SAS Institute, 2002).

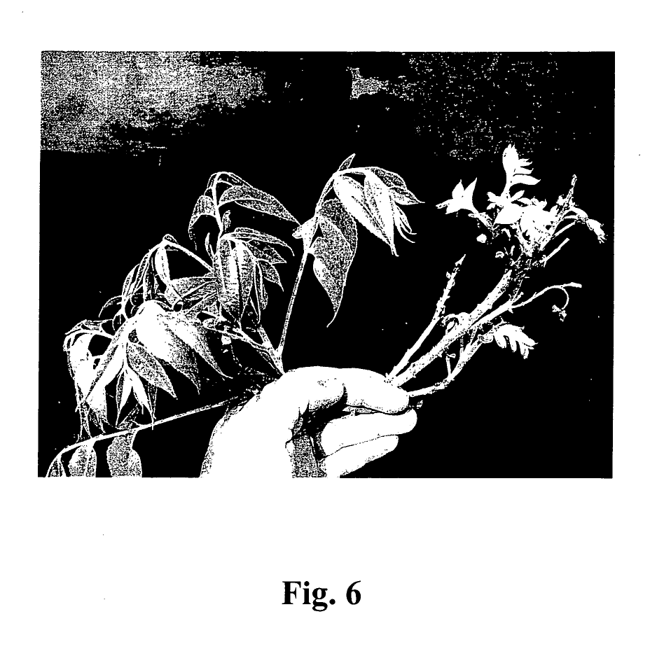

Limbs of trees receiving foliar sprays of nickel in October did not exhibit symptoms of mouse-ear the following spring whereas copper-treated and non-treated controls on the same tree exhibited severe mouse-ear (Table 5 and FIG. 6). Shoots arising from nickel treated branches exhibited a mouse-ear rating of 1, i.e., no symptoms of mouse-ear, whereas control trees exhibited a mouse-ear severity rating of 7.4, i.e., severe mouse-ear, and the copper treatment exhibited a severity rating of 7.6.

The October nickel treatment did not visually appear to be phytotoxic to either fall or spring foliage. These data indicate that the mouse-ear ‘replant disorder’ of young pecan trees is tightly linked to a physiological deficiency of nickel. Circumstantial evidence indicates that decades of zinc buildup in soils around trunks of old pecan trees from foliar sprays to correct zinc deficiency is likely contributing to competitive inhibition of spring nickel uptake by roots of transplanted trees. This may also be true for mature trees, but the degree of inhibition is usually insufficient to trigger mouse-ear symptoms; although, there may be unrecognized disruption of one or more growth and development processes via disruption of nickel associated physiology.

These data indicate that nickel is absorbed by pecan foliage and is translocated from foliage to storage pools in dormant season tissues of shoots and/or buds. The amount translocated was enough to correct the deficiency of nickel at bud break and to enable normal growth processes. Foliar nickel content the following spring was about 7 mg/kg in treatments receiving foliar nickel the previous October. This compares to nickel at about 0.5 mg/kg for foliage from non-treated tissues of trees exhibiting severe mouse-ear. Adjacent trees not exhibiting mouse-ear had a foliar nickel content of about 4 mg/kg.

TABLE 5
Influence of autumn applications of copper or
nickel to foliage of pecan trees in orchards.

| | |
|---|---|
| | Mouse-ear |
| Treatment | Severity^{w} |

| Chemical^{z} | Tree Type^{x} | (Class) |
|---|---|---|
| Control | Orchard Transplant | 7.4 a^{v} |
| Copper | Orchard Transplant | 7.6 a |
| Nickel | Orchard Transplant | 1.0 b |

^{z}Treated with sulfate salts of either copper or nickel with urea and nonionic surfactant as carrier. The control treatment received carriers but not salt.
^{x}Treated trees were orchard transplants
^{w}Severity class 1 = no mouse-ear symptoms, whereas class 10 = most severe symptoms (i.e., gross blunting, curling, necrosis of leaflets; plus stunted shoots, multiple shoots, and death of shoots.
^{v}Treatment means within each experiment are statistically different according to Tukey-Kramer HSD test (a = 0.05) if followed by different letters.

### EXAMPLE 9

In this example, copper and nickel were applied to expanding shoots soon after bud break in the spring. One of the orchards was the replant disorder orchard cited in Example 7. The experimental design and treatments were identical to that in Example 8 for autumn application except different trees were used. The expanding foliage and shoots were treated during the late parachute stage of leaf development in early April. All treatments contained urea at about 4.8 grams/liter and Bio-Surf (alky polyoxyethylene plus fatty acids), a nonionic surfactant, at about 2.5 ml/liter as additives and applied till run-off. Treatments were assessed and analyzed as in Example 8.

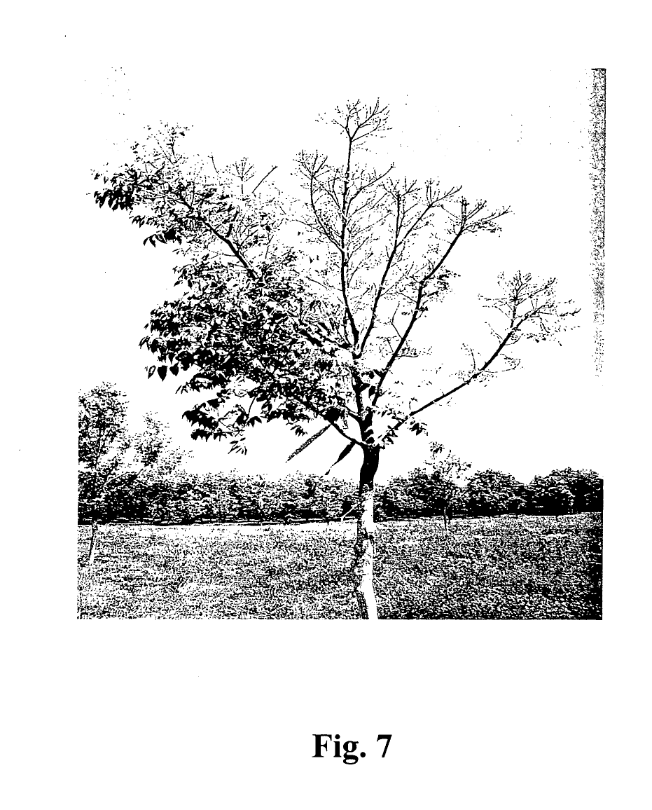

Randomly selected limbs of all treatments initially exhibited severe mouse-ear immediately after bud break, but prior to treatment with either copper or nickel. However, for the nickel treatment subsequent shoot, leaf, and leaflet growth after about 10-15 days no longer exhibited mouse-ear; whereas subsequent growth of copper-treated and the nontreated control shoots continued to exhibit severe mouse-ear symptoms (Table 6). Subsequent shoot growth arising from nickel treated branches exhibited a mouse-ear rating of 1=no symptoms whereas control branches exhibited severe mouse-ear at a rating of about 7.7 (Table 6 and FIG. 7). Conversely shoots arising from the spring copper treatment exhibited a severity rating of about 8.1, which was considerably more severe than the control treatment. Thus, the severity of mouse-ear can be increased by the foliar application of copper. The April nickel foliar application induced slight, yet noticeable, phytotoxicity to young foliage insomuch that leaflet tips and margins sometimes possessed small necrotic spots.

Nickel content of foliage from branches of trees treated with nickel to correct mouse-ear was about 26 mg·Kg⁻¹ dw (dry weight) as compared to about 0.4 mg·kg⁻¹ dw/.

These data confirm the findings of the autumn treatments that the mouse-ear replant disorder of young pecan trees is tightly linked to nickel and is due to a nickel deficiency. The spotty necrosis of very young developing foliage indicates that the optimal concentration of nickel for spring application is considerably less than that used in the present study. The ability of foliar sprays of copper to increase the severity of mouse-ear is taken as evidence that high copper content may potentially disrupt nickel associated physiological processes. Anecdotal observations indicate that excessive foliar iron can also induce a nickel deficiency.

The ability of the nickel sprays to cure the mouse-ear associated replant disorder being exhibited by pecan trees in a 2^{nd} generation orchard, as described in Example 7, clearly indicates that the replant disorder is due to a nickel deficiency. The high amount of soil zinc at the replant sites, and the ability of zinc to inhibit uptake of nickel from soil by roots, is strong evidence that the nickel associated replant disorder is due to a zinc induced nickel deficiency in replanted trees. Since nickel, zinc, and copper are direct competitors at the absorption channels in roots, high soil levels of any one of the three divalent cations can inhibit uptake of the other two cations, potentially causing a deficiency in one of these if one of the others is excessively high. Additionally, because calcium and magnesium are indirect competitors of nickel uptake by roots in soils, excessive soil levels of calcium and magnesium can also induce a nickel deficiency. Thus, accumulation of excessive amounts of zinc, copper, magnesium, and calcium by fertilization of orchard and vineyard soils over the years contributed to metal induced nickel deficiencies in crops. Foliar spraying with nickel is a means of correcting these nickel associated replant disorders.

TABLE 6
Influence of early spring applications of copper or
nickel to foliage of pecan trees in orchards.

| | |
|---|---|
| | Mouse-ear |
| Treatment | Severity^{w} |

| Chemical^{z} | Tree Type^{x} | (Class) |
|---|---|---|
| Control | Orchard Transplant | 7.7 b^{v} |
| Copper | Orchard Transplant | 8.1 a |
| Nickel | Orchard Transplant | 1.0 c |

^{z}Treated with sulfate salts of either copper or nickel with urea and nonionic surfactant as carrier. The control treatment received carriers but not salt.
^{x}Treated trees were orchard transplants
^{w}Severity class 1 = no mouse-ear symptoms, whereas class 10 = most severe symptoms (i.e., gross blunting, curling, necrosis of leaflets; plus stunted shoots, multiple shoots, and death of shoots.
^{v}Treatment means within each experiment are statistically different according to Tukey-Kramer HSD test (a = 0.05) if followed by different letters.

### EXAMPLE 10

The influence of copper and nickel on mouse-ear of potted seedlings was evaluated by treating 1-year-old ‘Desirable’ pecan seedlings potted in soil from an orchard exhibiting severe mouse-ear near Cordele, Ga. Seedling trees were germinated in May in vermiculite and transplanted in June to 15 cm×10 cm rectangular plastic pots containing soil which was about 95% sand, 0% silt, 4% clay with a pH about 7.0 and organic matter (o.m.) about 1.3%. Trees were treated in October, just before leaf drop, with a single foliar spray of either copper or nickel. Copper or nickel were applied at one of five concentrations: 0, 1X, 2X, 4X, and 8X; where for copper, X=about 1.98 grams CuSO₄.H₂O per liter and for Nickel X=3.53 grams NiSO₄.6H₂O per liter. Spray application till run-off soaked the foliage while a barrier was used to prevent soil contamination. Trees were maintained until natural leaf drop in November by watering beneath the foliar canopy. Treated seedlings were left in the unheated greenhouse during the dormant season. Trees broke bud about March 15 and were subsequently rated for mouse-ear severity using the scale described above for treatment differences. The study was structured as two distinct experiments structured as a RCB design with three blocks of five elemental concentrations and eight trees per experimental unit. All treatments contained urea at 4.8 grams/liter and Bio-Surf (an alkyl polyoxyethylene plus fatty acids), a nonionic surfactant, at about 2.5 ml/liter as additives.

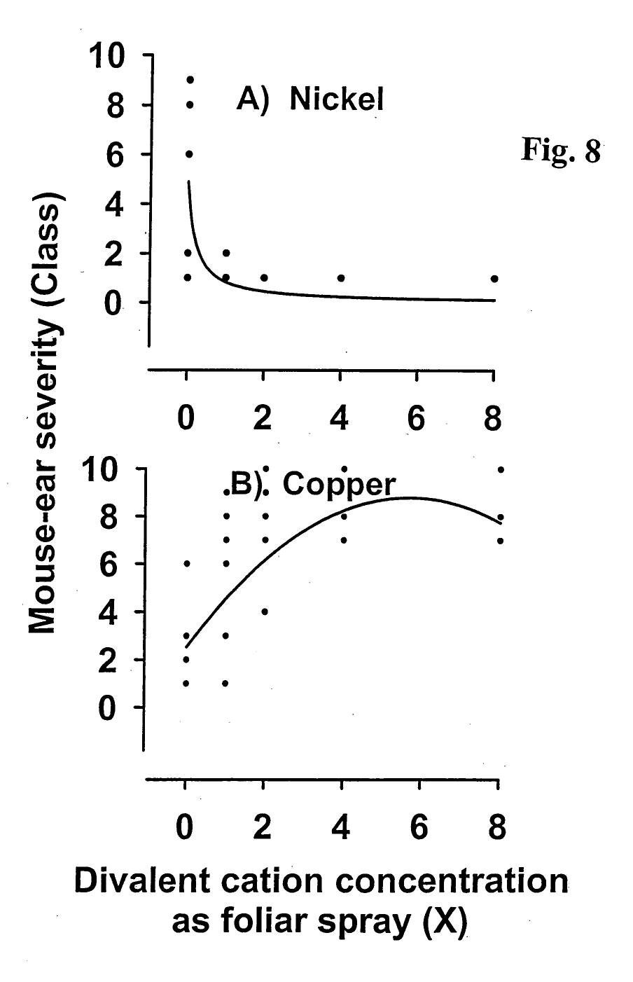

Foliar application of nickel and copper to the seedling trees in the greenhouse was such that nickel reduced severity and copper increased mouse-ear severity (FIG. 8). The severity of mouse-ear decreased greatly with nickel treatments ≧1X. No mouse-ear was evident in the 2X, 4X and 8X treatments, and very little in the 1X treatment. These data support those from the field trees that fall applications of nickel to foliage will prevent the occurrence of mouse-ear the following spring. Conversely, autumn application of copper to seedling trees failed to correct mouse-ear and actually increased severity of mouse-ear as the concentration of applied copper increased (FIG. 8). Thus, mouse-ear does not appear to be associated with a copper deficiency. This increased severity of mouse-ear in copper treated seedlings, as a result of increasing amounts of foliar copper applied the previous October, provides evidence that excessive copper is interfering with nickel related physiological processes.

### EXAMPLE 11

For the spring greenhouse study, mouse-ear affected trees, previously treated in the fall with high amounts of copper as described above in Example 10, were segregated and randomized and structured such that they were treated with a foliar spray of NiSO₄.6H₂O after copper treatments, regardless of the amount of autumn copper applied to foliage, exhibited severe mouse-ear the following spring. Experimental design was a RCB comprised of 3 blocks (blocked by severity of mouse-ear) of two nickel treatments: 0 versus about 3.53 grams/liter as the sulfate salt; with four trees per experimental unit. Nickel treatments were applied early May and the new shoot growth subsequently evaluated for mouse-ear severity. All treatments included urea at about 4.8 grams/liter and Bio-Surf (an alkyl polyoxyethylene plus fatty acids), a nonionic surfactant, at about 2.5 ml/liter as additives. Data were statistically analyzed for treatment differences as described in Example 8.

Application of nickel two weeks after bud break to mouse-ear seedlings previously treated with high amounts of copper corrected mouse-ear symptoms in developing shoots expanding subsequent to nickel treatment, but had no curative effect on the morphology of older leaflets present prior to nickel application (Table 7). These data (a) support the above described field studies that post bud break foliar application of nickel can correct mouse-ear of expanding foliage, (b) indicates that nickel corrects the increased severity of mouse-ear caused by foliar sprays of copper, and (c) that nickel and copper are likely competing in certain physiological processes.

TABLE 7
Influence of Spring Application of nickel to foliage of
potted pecan seedlings in a greenhouse.

| | | Mouse-ear |
|---|---|---|
| | | Severity^{w} |
| Chemical^{z} | Tree Type^{x} | (Class) |
| Control | Greenhouse Seedling^{u} | 8.1 a^{v} |
| Nickel | Greenhouse Seedling | 1.0 b |

^{z}Treated with sulfate salts of nickel with urea and nonionic surfactant as carrier. The control treatment received carriers but not salt.
^{x}Treated trees were seedlings growing in a greenhouse with treatment applied in mid-April
^{w}Severity class 1 = no mouse-ear symptoms, whereas class 10 = most severe symptoms (i.e., gross blunting, curling, necrosis of leaflets; plus stunted shoots, multiple shoots, and death of shoots.
^{v}Treatment means within each experiment are statistically different according to Tukey-Kramer HSD test (a = 0.05) if followed by different letters.

### EXAMPLE 12

To determine the minimum concentrations of nickel required to at least minimize mouse-ear in pecan trees, nickel sources were applied to foliage at different solution concentrations during spring bud break of pecan seedlings exhibiting severe nickel deficiency, i.e., mouse-ear. Nickel foliar sprays were prepared by mixing nickel sulfate hexahydrate, nickel lignosulfonate, or an aqueous extract of Alyssum which is a nickel accumulating plant in distilled water and about 0.05% Bio-Surf (an alkyl polyoxyethylene plus fatty acids), a nonionic surfactant. Concentrations of nickel applied as a foliar spray included about 0, 0.001, 0.01, 0. 1, 1, 10, 100, and 1000 ppm or mg·L⁻¹. The 0 (control) treatment was the control and contained Bio-Surf and distilled water only. To prepare the Alyssum extract, about 30 grams of finely ground Alyssum biomass was mixed with about 1,000 ml of deionized distilled water and heated to near boiling while being stirred using a magnetic stir plate and bar. Heat was then turned off and the solution stirred for about 24 hours. The solution was then filtered and/or centrifuged to remove particulate matter and the solution was then frozen until needed. This procedure yielded about 90% extraction efficiency. Depending upon the batch, the extract yielded a nickel content of about 400-700 ppm or mg·L⁻¹.

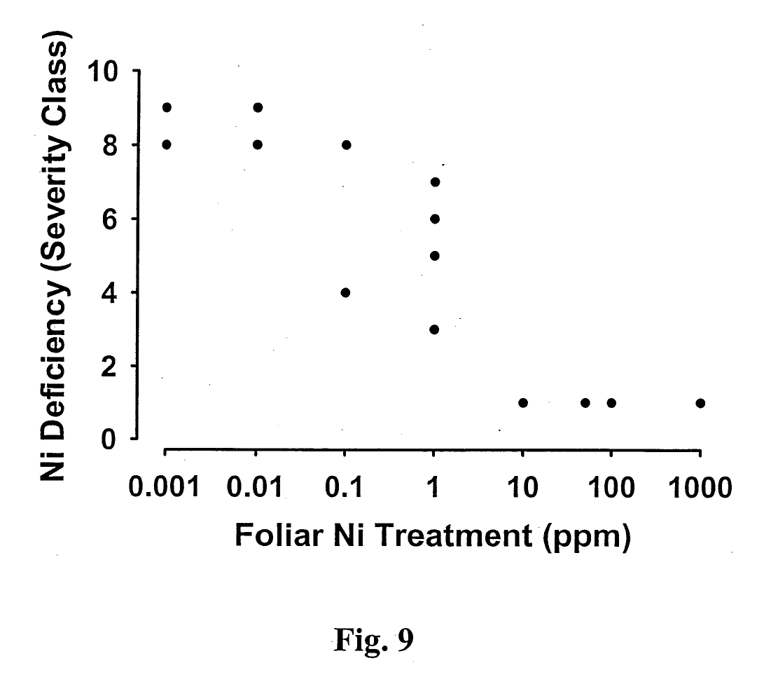

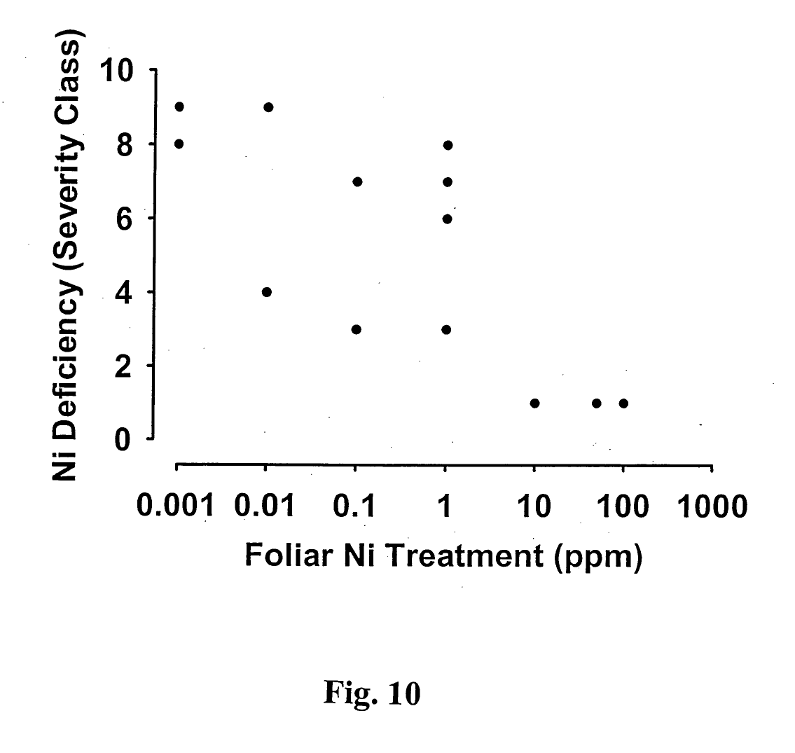

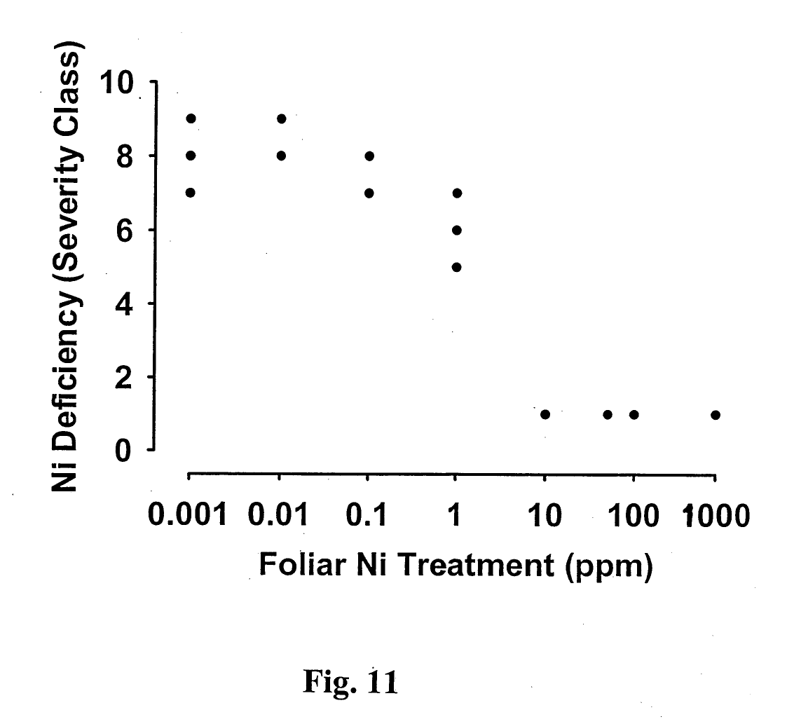

Foliar applications of nickel corrected nickel deficiency when applied at concentrations of about 10 ppm or mg·L⁻¹ or greater. All three nickel sources, i.e., one inorganic and two organic with one of these being a natural product, were equally effective in correction of nickel deficiency in pecan. Little or no correction was evident when applied at about 1 ppm or mg·L⁻¹ or less. See FIGS. 9, 10, and 11.

### EXAMPLE 13

The efficacy of organic as well as inorganic nickel sources was tested by applying these to pecan seedlings exhibiting mouse-ear in October. They were assessed for their ability to correct mouse-ear upon bud break the following spring. Sources included 4 organic sources: aqueous extract of Alyssum which is a natural product (See example 12 above), nickel gluconate (although sometimes referred to as gluconsate or glucoheptanate in certain literature), nickel sulfamate tetrahydrate, and nickel acetate tetrahydrate; and 4 inorganic sources including nickel chloride hexahydrate, nickel nitrate hexahydrate, nickel lignosulfonate, and nickel sulfate hexahydrate. They were all applied at a nickel metal concentration of about 100 ppm as a foliar spray including Bio-Surf at a concentration of 0.05%. The control was distilled water and surfactant.

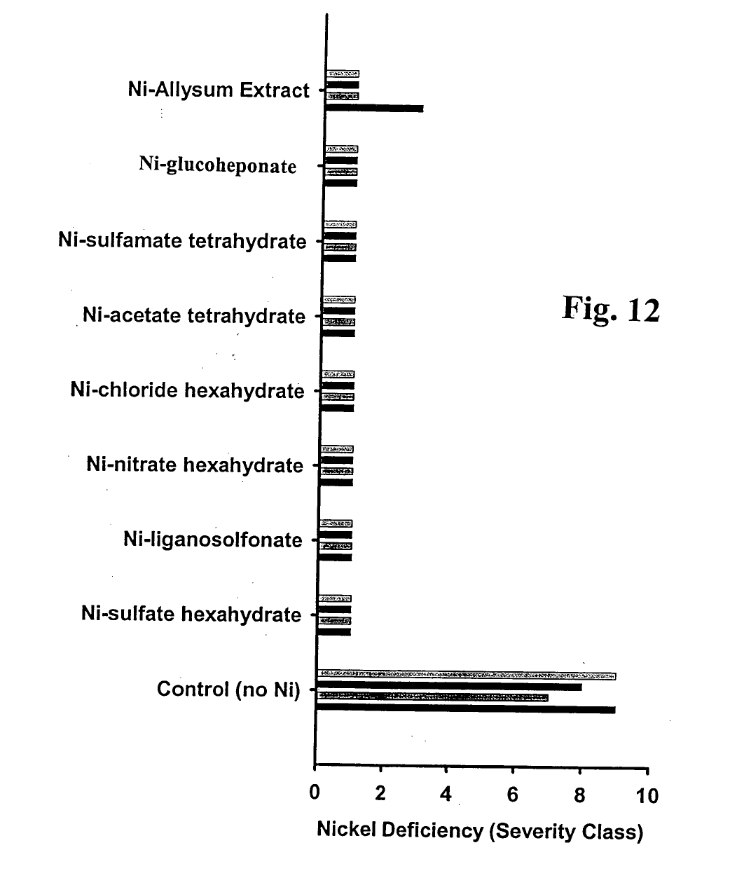

FIG. 12 shows that fall applications of all 8 sources of nickel corrected mouse-ear in pecan seedlings as expressed the following spring.

### EXAMPLE 14

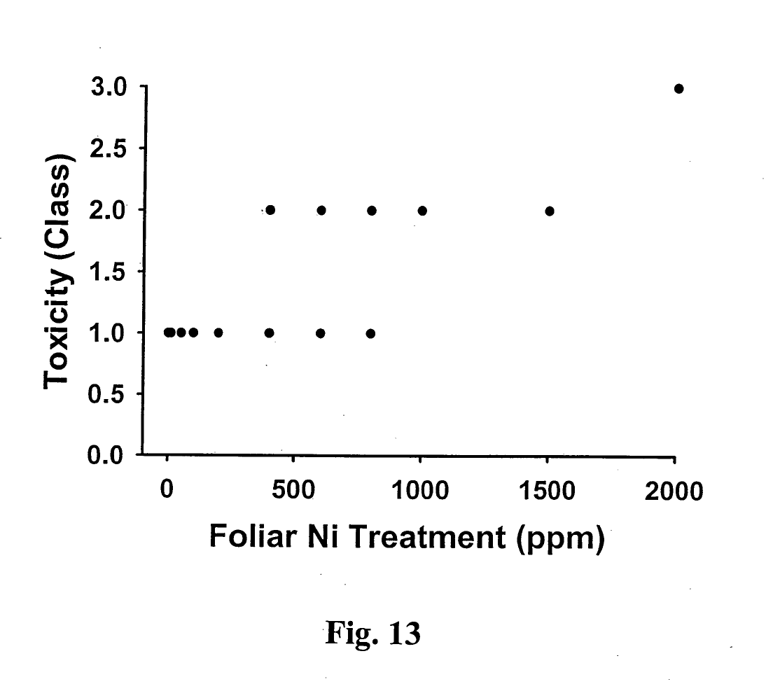

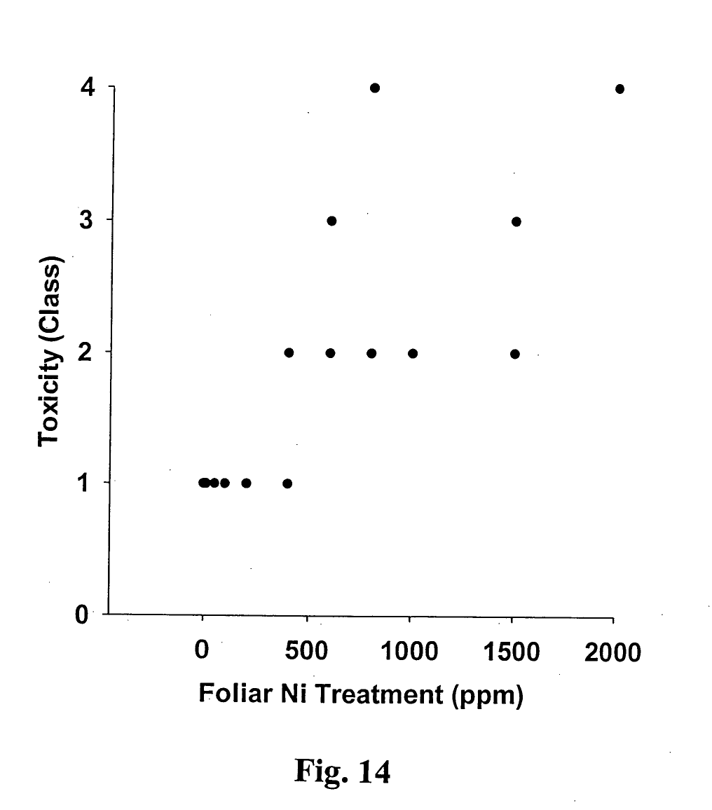

The toxicity of nickel on plants was tested by applying a single foliar application of nickel to young foliage of pecan and tomato plants. The nickel concentration treatments included about 0, 10, 100, 200, 400, 600,. 800, 1000, 1500, and 2000 ppm or mg·L⁻¹ of nickel in distilled water including about 0.05% Bio-Surf. Young foliage was visually rated for nickel phytotoxicity about seven days post treatment. The nickel source was nickel sulfate hexahydrate. For the pecan, nickel was not damaging until treatment concentrations reached about 400 ppm or mg·L⁻¹ (See FIG. 13). For tomato, nickel was not damaging until nickel treatments reached about 400 ppm or mg·L⁻¹ (See FIG. 14). Therefore, it appears that nickel is phytotoxic at concentrations somewhere between about 200 ppm or mg·L⁻¹ and 400 ppm or mg·L⁻¹.

### EXAMPLE 15

The efficacy of October foliar applications of inorganic or organic sources of nickel on mouse-ear symptoms the following spring were studied by applying a single foliar application of nickel to mature foliage of young pecan trees in orchards during October. The nickel concentration treatments were about 0 and about 100 ppm or mg·L⁻¹ of nickel in distilled water with about 0.05% Bio-Surf. Sources of nickel included nickel Alyssum extract, nickel lignosulfonate, nickel gluconate (although sometimes referred to as gluconsate or glucoheptanate in certain literature), and nickel sulfate hexahydrate with the control being distilled water and about 0.05% Bio-Surf. Foliage was rated for corrected mouse-ear symptoms the following spring after bud break.

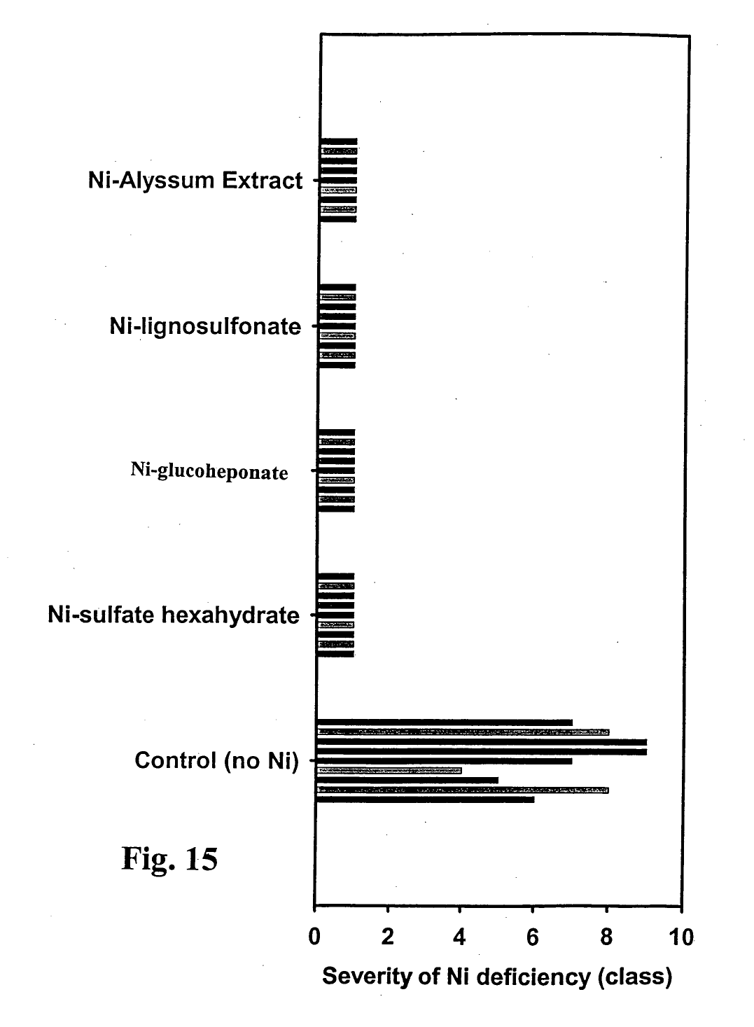

All three organic sources of nickel including the nickel-Alyssum extract as well as the nickel sulfate hexahydrate corrected mouse-ear (See FIG. 15).

### EXAMPLE 16

The efficacy of organic nickel sources and inorganic sources on correction of mouse-ear in pecans when applied in spring during early stages of bud break was assessed. The nickel was applied to pecan trees in orchards at concentrations of about 0 or about 100 ppm or mg·L⁻¹ as described in the above examples. Sources of nickel included nickel-Alyssum extract, nickel lignosulfonate, nickel sulfate hexahydrate, and control (distilled water and about 0.05% Bio-Surf).

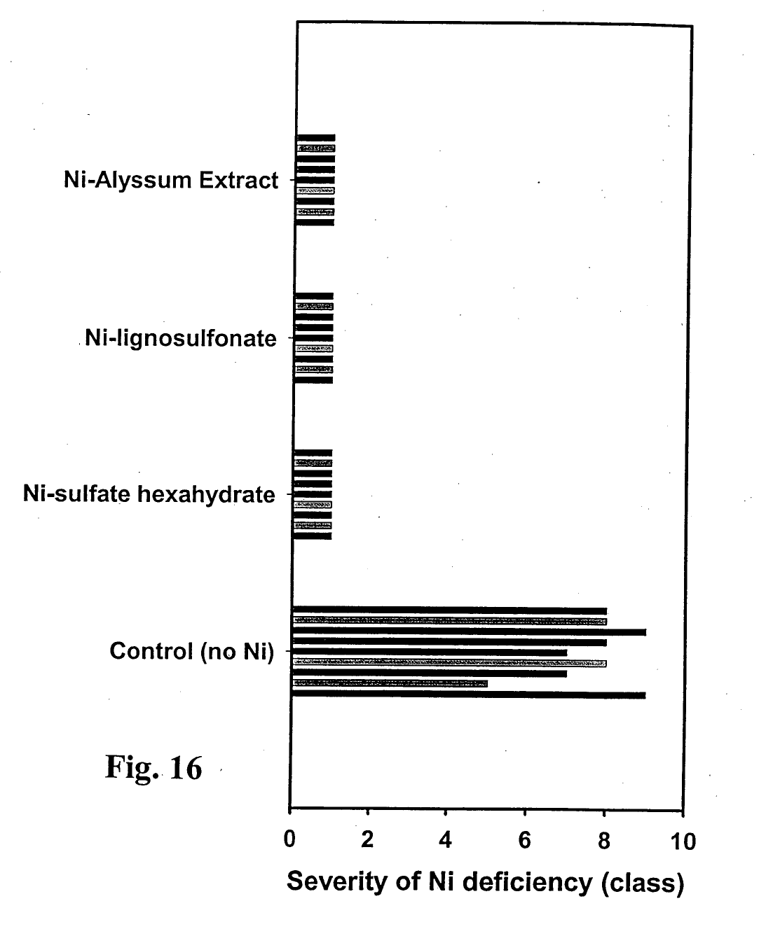

All three sources of nickel corrected mouse-ear (See FIG. 16).

### EXAMPLE 17

To show that nickel is absorbed by plants other than pecan, young Indian Mustard plants were treated with a foliar application of about 135 ppm or mg·L⁻¹ of nickel from different sources. Sources were Alyssum extract, nickel glucoheptonate, nickel lignosulfonate as Complex R, nickel lignosulfonate as Complex M, and nickel sulfate hexahydrate. Plants were sampled about 7 days after treatment and analyzed for nickel via Inductively Coupled Plasma Spectrometry (ICP). Additionally, the nickel-Alyssum extract, Ni-lignosulfonate as Complex M, and Ni-sulfate hexahydrate were applied to Indian Mustard plants as a foliar spray at nickel concentrations of about 0, 25, 50, 100, 150, 200, and 350 ppm or mg·L⁻¹.

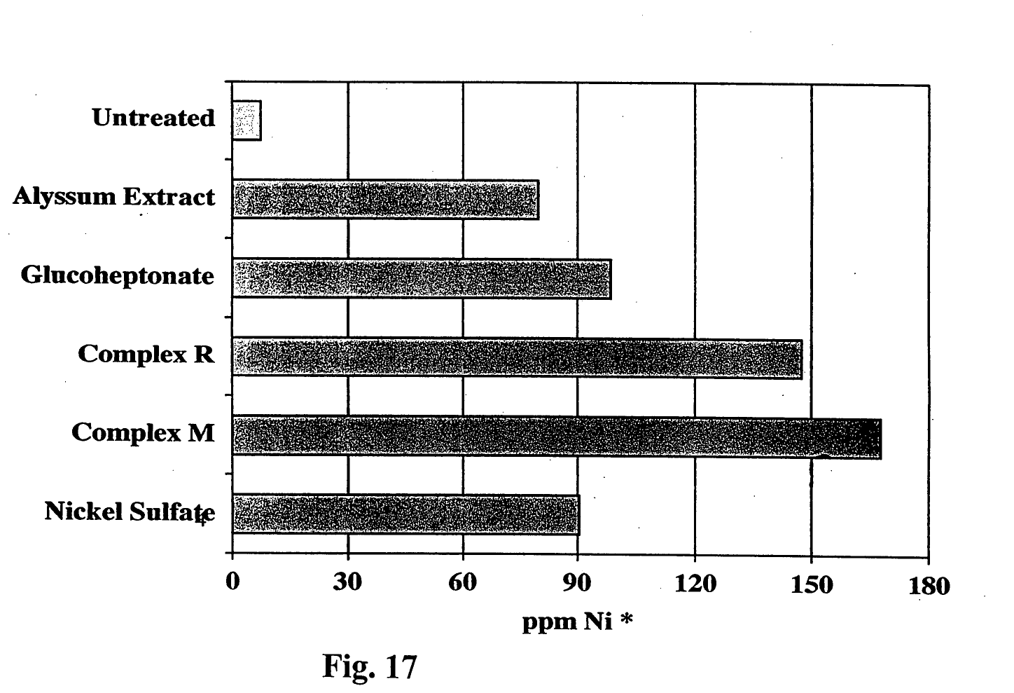

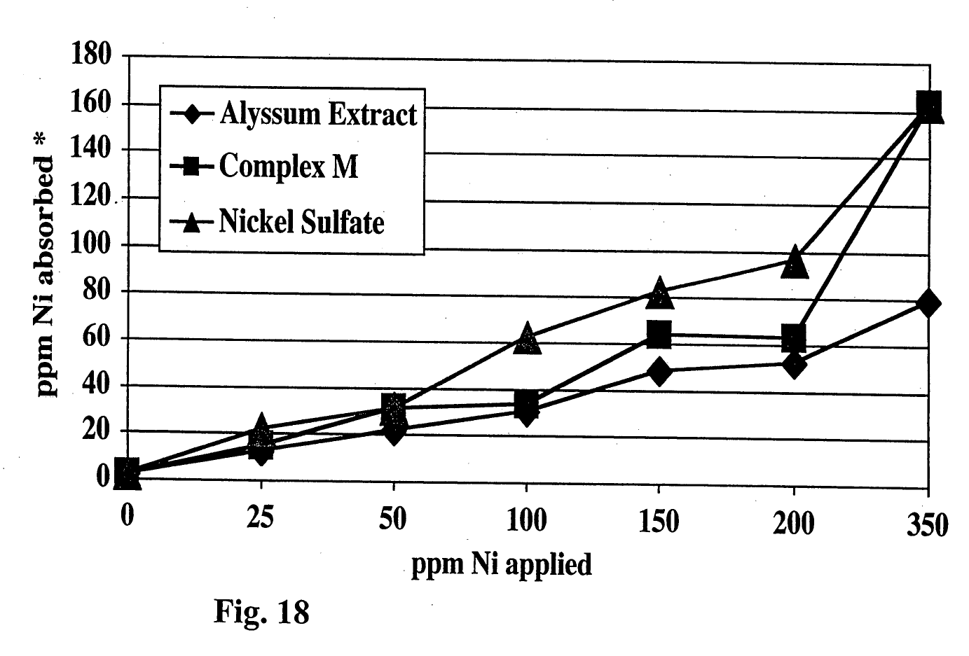

FIGS. 17 and 18 show that Indian Mustard plants absorbed nickel from all tested sources of nickel. The Alyssum extract increased foliar nickel content from about 8 ppm or 8 mg·L⁻¹ to about 80 ppm or 80 mg·L⁻¹ showing that the Alyssum extract of Alyssum dry matter was able to serve as a nickel source allowing for the absorption of nickel by foliage. Also, application of nickel from Alyssum and other sources resulted in an increase in nickel content of foliage as the concentration of the nickel spray increased demonstrating that Alyssum is an effective source of nickel for foliar absorption (FIG. 18). Note that this measured foliage is in reference to that which grew after the application of Ni from Alyssum and is therefore not surface contaminated with Ni.

The foregoing detailed description is for the purpose of illustration. Such detail is solely for that purpose and those skilled in the art can make variations without departing from the spirit and scope of the invention.

1. A composition for plants with growth disorders caused by a nickel deficiency comprising nickel in an amount effective to at least reduce the severity of a plant growth disorder.

2. The composition of claim 1 wherein said nickel is an organic or inorganic nickel.

3. The composition of claim 2 wherein said organic nickel is selected from the group consisting of an aqueous extract of a plant used for phytoextraction of nickel from contaminated soils or mineralized soils, a biomass of at least one nickel accumulating plant, a nickel lignosulfonate, nickel gluconate, nickel sulfamate tetrahydrate, nickel acetate tetrahydrate, and mixtures thereof.

4. The composition of claim 3 wherein the organic nickel is a biomass of at least one nickel accumulating plant.

5. The composition of claim 2 wherein said inorganic nickel is selected from the group consisting of nickel chloride hexahydrate, nickel nitrate hexahydrate, nickel sulfate hexahydrate, anhydrous nickel salts, hydrated nickel sulfate, hydrated nickel nitrate, hydrated nickel chloride, and mixtures thereof.

6. The composition of claim 1 wherein said composition is a foliar spray further comprising a nonionic surfactant and an aqueous carrier.

7. A method for treating plants having growth disorders associated with a nickel deficiency comprising:
applying a composition comprising a nickel in an amount effective to at least reduce the severity of a plant abnormality.

8. The method of claim 7 wherein said nickel is an organic or inorganic nickel.

9. The method of claim 8 wherein said organic nickel is selected from the group consisting of an aqueous extract of a plant used for phytoextraction of nickel contaminated soils, a biomass of at least one nickel accumulating plant, a nickel lignosulfonate, nickel gluconate, nickel sulfamate tetrahydrate, nickel acetate tetrahydrate, and mixtures thereof.

10. The method of claim 7 wherein said composition is a foliar spray further comprising a nonionic surfactant and an aqueous carrier.

11. The method of claim 9 wherein said organic nickel is a biomass of at least one nickel accumulating plant.

12. The method of claim 8 wherein said inorganic nickel is selected from the group consisting of nickel chloride hexahydrate, nickel nitrate hexahydrate, nickel sulfate hexahydrate, anhydrous nickel salts, hydrated nickel sulfate, hydrated nickel nitrate, hydrated nickel chloride, and mixtures thereof.

13. The method of claim 10 wherein said foliar spray composition is applied to trees with growth disorders in the fall.

14. The method of claim 9 wherein said foliar spray composition is applied to trees with growth disorders in the spring post bud break.

15. The method of claim 7 wherein said composition is applied to the ground or soil.
